(19) United States
(12) Patent Application Publication
(10) Pub. No.: US 2002/0073121 A1
(43) Pub. Date: Jun. 13, 2002

(54) Publication editing system and method

(76) Inventors: Michio Sano, Tokyo (JP); Toshimitsu Miyamoto, Tokyo (JP); Kazuhisa Iwasaki, Tokyo (JP)

Correspondence Address: RABIN & CHAMPAGNE, PC, 1101 14TH STREET, NW, SUITE 500, WASHINGTON, DC, 20005, US

(21) Appl. No.: 09/905,960

(22) Filed: Jul. 17, 2001

(30) Foreign Application Priority Data
Jul. 18, 2000 (JP) 2000-217102
Jun. 13, 2001 (JP) 2001-178833

(51) Int. Cl. G06F 15/00; G06F 17/24; G06F 17/21

(52) U.S. Cl. 707/517; 707/530

(57) ABSTRACT

The present invention provides a publication editing system, comprising: a template display means connected with a user terminal to display a template composed of a combined arrangement of a text area and a image area; a printing information forming means for forming printing information to allow the associated information with the input text and the combination of the image and the template to be output as the publication; and a printing/binding means for printing and binding based on the printing information to provide a finished book.

### FIELD OF THE INVENTION

The present invention relates to a publication editing system and method capable of allowing a publication to be readily edited on an on-line terminal by use of templates which are transmitted from a server to the on-line terminal, and additionally allowing the edited publication to be printed and bound to provide a required number of books.

### BACKGROUND OF THE INVENTION

Heretofore, for editing a publication on a personal computer (hereinafter referred to as “PC”) preparatory for printing and binding the publication, it has been common for a user to install the desktop publishing (DTP) application software in his/her PC to construct a DTP environment and then edit the publication using the software. For printing and binding the resulting publication through the edition in the DTP environment to shape into books, it has been necessary to make the edited publication into printed documents output from a printer or a medium having an electronic data of the edited publication recorded thereon to bring it to a printing/binding agent and give out a desired order.

However, the user is required to bear considerable expenses for constructing the DTP environment in own PC, including buying expenses of the DTP application software, a scanner or a printer. The user is also required to get over technical difficulties involved with constructing the DTP environment in own PC. Further, the user has to master directions of the installed DTP application software. Generally, high-level multi-functions are incorporated in the DTP application software. Thus, even in preparing a publication using only a part of the functions in the DTP application software, a light-user is required to inefficiently learn its entire operation scheme. These undesirably impose a significantly heavy burden particularly on users who use the DTP application software non-professionally. Furthermore, for printing and binding the edited publication, the user has to spend time and money for placing an order with a printing/binding agent and additionally to arrange the delivery date of finished products with a certain margin of time. Particularly, in case of a small number of publications, the user is generally required to spend a lot of time and effort to find out an open-armed printing/binding agent and negotiate the ordering conditions of such a small number of publications. This means a great deal of underlying needs in such a case. In addition, when ordering to a printing/binding agent through printed documents output from a printer, finished products or books can be undesirably degraded in print quality due to poor quality of the printed documents. When ordering through electronic data, finished books can be provided with a different appearance from that expected by the user, due to some difference in the version of the DTP application software, system configuration or hardware between the user and the printing/binding agent.

### SUMMARY OF THE INVENTION

In view of the aforementioned problems, it is therefore an object of the present invention to provide a system and method capable of providing a template having a combined arrangement or layout of a text area and an image area from a WWW server for managing a binding data of publications to a user terminal provided with a WWW browser via the Internet to allow the publication to be readily edited from the user terminal through the template and to allow the edited publication to be printed and bound by a printing/binding means on the basis of printing information on the edited publication only for the number of copies specified by a user on the Internet so as to provide finished books in a simplified manner.

The aforementioned object can be achieved by the present invention having the following specific features. According to a first aspect of the present invention, there is provided a publication editing system comprising: a user terminal used by a user who provides information on a publication; an editing computer connected with the user terminal and for editing the publication based on the information and instructions from the user; an image information storage means for allowing the editing computer to store image information provided from the user; a template data storage means for allowing the editing computer to store a data of a template to be displayed on a screen of the user terminal in combination with the image information; a template display means for displaying the image and template in combination thereof on said screen of said user terminal, which are specified by the instructions from the user; a text input means for inputting a text through the template combined with the image according to the instructions from the user terminal by the user; and a printing information forming means for forming printing information to allow the associated information with the input text and the combination of the image and the template to be output as the publication.

According to an additional feature in the first aspect of the present invention, the template display means may be adapted to transmit the image information, which includes a less amount of information than that of the corresponding image information stored in the image information storage means, to the user terminal.

According to another additional feature in the first aspect of the present invention, the template display means may be adapted to allow a WWW browser operable on the user terminal to display the template. In this case, the publication editing system may further include a template data holding means for holding the template data provided for the WWW browser by the template display means to allow the WWW browser to be applied in an editing operation through the template even in an off-line state of the user terminal.

According to still another additional feature in the first aspect of the present invention, the publication editing system may further include an image information editing means for editing the image information stored in the image information storage means, according to a parameter specified from the user terminal by the user.

According to yet another additional feature in the first aspect of the present invention, the publication editing system may further include a printing/binding means for printing and binding a required number of publications based on the printing information. In this case, the printing/binding means may be placed in the vicinity of a shop including a bookshop to allow the publication printed and bound by the printing/binding means to be appropriately collected at the shop.

According to a second aspect of the present invention, there is provided a publication editing method of editing a publication based on information and instructions from a user who provides information on the publication, the publication editing method comprising the steps of: storing image information provided from the user in an editing computer; storing a data of a template to be displayed on a screen of a user terminal in combination with the image information, in the editing computer; displaying the image and template in combination thereof on said screen of said user terminal, which are specified by instructions from the user; inputting a text through the template combined with the image according to the instructions from the user terminal by the user; and forming printing information to allow the associated information with the input text and the combination of the image and the template to be output as the publication.

According to a third aspect of the present invention, there is provided a server for implementing a publication editing method of editing a publication based on information and instructions from a user who provides information on the publication, the publication editing method comprising the steps of: storing image information provided from the user in an editing computer; storing a data of a template to be displayed on a screen of a user terminal in combination with the image information, in the editing computer; displaying the image and template in combination thereof on said screen of said user terminal, which are specified by instructions from the user; inputting a text through the template selectively combined with the image according to the instructions from the user terminal by the user; and forming printing information to allow the associated information with the input text and the combination of the image and the template to be output as the publication.

According to a fourth aspect of the present invention, there is provided a publication editing system comprising: a user terminal used by a user who provides information on a publication; an editing computer connected with the user terminal and for editing the publication based on the information and instructions from the user; a template data storage means incorporated in the editing computer and for storing a template data representing a template to be displayed on a screen of the user terminal with an image and text arranged at a given position of the template; a template display means incorporated in the editing computer and for transmitting the template data to the user terminal so as to display the template on the user terminal; an image information path input means incorporated in the editing computer and for inputting a file path of image information in the user terminal, through the user terminal; an image position input means incorporated in the editing computer and for inputting positional information, which represents a position of the image on the template represented by the image information having the input path, through the user terminal in association with the image information; a text information input means incorporated in the editing computer and for inputting text information in association with the positional information which includes a text to be displayed on the template, through the user terminal; a text information storage means incorporated in the editing computer and for storing the text information input by the text information input means, in association with the positional information of the input text information; a constructed screen display means incorporated in the editing computer and for constructing a display data, which allows the image represented by the image information having the input path and the text represented by the input text information to be displayed on the user terminal with them arranged at each corresponding position on the template represented by the positional information associated with each of the image information and the text information, and for transmitting the display data to the user terminal; an image information input means incorporated in the editing computer and for inputting the image information having the input path through the user terminal; an image information storage means incorporated in the editing computer and for storing the image information input by the image information input means, in association with the positional information of the image information; and a printing information forming means incorporated in the editing computer and for forming printing information used for outputting a specific image including the image presented by the stored image information and the text presented by the stored text information, which are arranged at each corresponding position on the template presented by the positional information associated with each of the image information and the text information, as a publication.

According to a fifth aspect of the present invention, there is provided a publication editing system comprising: a user terminal used by a user who provides information on a publication; an image providing WWW server connected with the user terminal and for providing image information to the WWW; an editing computer connected with the user terminal and the image providing WWW server so as to edit the publication based on the information and instructions from the user; a template data storage means incorporated in the editing computer and for storing a template data representing a template to be displayed on a screen of the user terminal with an image and text arranged at a given position of the template; a template display means incorporated in the editing computer and for transmitting the template data to the user terminal so as to display the template on the user terminal; an image information address input means incorporated in the editing computer and for inputting a file address of the image information in the image providing WWW server, through the user terminal; a provided image receiving means incorporated in the user terminal and for receiving the image information having the input address from the image providing WWW server by requesting the image information to the image providing WWW server; a provided image position input means incorporated in the editing computer and for inputting positional information in association with said image information, which represents a position of the image on the template represented by the image information having the input address, through the user terminal; a text information input means incorporated in the editing computer and for inputting text information in association with the positional information representing the position on the template through the user terminal, which includes a text to be displayed on the template; a text information storage means incorporated in the editing computer and for storing the text information input by the text information input means, in association with the positional information of the input text information; a constructed screen display means incorporated in the editing computer and for constructing a display data, which allows the image represented by the image information having the input path and the text represented by the input text information to be displayed on the user terminal with them arranged at each corresponding position on the template represented by the positional information associated with each of the image information and the text information, and for transmitting the display data to the user terminal; an image information receive means incorporated in the editing computer and for receiving the image information having the input address from the image providing WWW server by requesting the image information to the image providing WWW server; an image information storage means incorporated in the editing computer and for storing the image information received by the image information receive means, in association with the positional information of the image information; and a printing information forming means incorporated in the editing computer and for forming printing information used for outputting a specific image including the image represented by the stored image information and the text represented by the stored text information, which are arranged at each corresponding position on the template represented by the positional information associated with each of the image information and the text information, as a publication.

According to an additional feature in the fourth or fifth aspect of the present invention, the template display means may be adapted to allow a WWW browser operable on the user terminal to display the template. In this case, the publication editing system may further include a template data holding means for holding the template data provided for the WWW browser by the template display means to allow the WWW browser to be applied in an editing operation through the template even in an off-line state of the user terminal.

According to another additional feature in the fourth or fifth aspect of the present invention, the publication editing system may further include a printing/binding means for printing and binding a required number of publications based on the printing information. In this case, the printing/binding means may be placed in the vicinity of a shop including a bookshop to allow the publication printed and bound by the printing/binding means to be appropriately collected at the shop.

According to a sixth aspect of the present invention, there is provided a publication editing method of editing a publication based on information and instructions from a user who provides information on the publication, the method comprising the steps of: storing a template data representing a template to be displayed on a screen of a user terminal with an image and text arranged at a given position of the template; transmitting the template data to the user terminal so as to display the template on the user terminal; inputting a file path of the image information in the user terminal, through the user terminal; inputting positional information in association with the image information through the user terminal, the positional information representing the position of the image on the template presented by the image information having the input path; inputting text information in association with the positional information representing the position of the image on the template through the user terminal, the text information including a text to be displayed on the template; storing the text information input in the step of inputting text information, in association with the positional information of the input text information; constructing a display data, which allows the image represented by the image information having the input path and the text represented by the input text information to be displayed on the user terminal with them arranged at each corresponding position on the template represented by the positional information associated with each of the image information and the text information, and then transmitting the display data to the user terminal; inputting the image information having the input path, through the user terminal; storing the image information input in the step of inputting the image information, in association with the positional information of the image information; and forming printing information for outputting a specific image, which includes the image represented by the stored image information and the text represented by the stored text information, which are arranged at each corresponding position on the template represented by the positional information associated with each of the image information and the text information, as a publication.

According to a seventh aspect of the present invention, there is provided a publication editing method of editing a publication by use of image information provided by an image providing WWW server, based on the information and instructions through a user terminal from a user who provides information on the publication, the publication editing method comprising the steps of: storing a template data representing a template to be displayed on a screen of a user terminal with an image and text arranged at a given position of the template; transmitting the template data to the user terminal so as to display the template on the user terminal; inputting a file address of the image information in the image providing WWW server, through the user terminal; receiving the image information having the input address from the image providing WWW server by requesting the image information to the image providing WWW server; inputting positional information in association with said image information, which represents the position of the image on the template represented by the image information having the input address, through the user terminal in association with the image information; inputting text information in association with the positional information representing the position of the image on the template through the user terminal, which includes a text to be displayed on the template; storing the text information input in the step of inputting text information, in association with the positional information of the input text information; constructing a display data, which allows the image represented by the image information having the input path and the text represented by the input text information to be displayed on the user terminal with them arranged at each corresponding position on the template represented by the positional information associated with each of the image information and the text information, and then transmitting the display data to the user terminal; receiving the image information having the input address from the image providing WWW server by requesting the image information to the image providing WWW server; storing the image information received in the step of receiving the image information, in association with the positional information of the image information; and forming printing information for outputting a specific image including the image represented by the stored image information and the text represented by the stored text information, which are arranged each at corresponding position on the template represented by the positional information associated with each of the image information and the text information, as a publication.

### BRIEF DESCRIPTION OF THE DRAWINGS

FIG. 1 is a block diagram showing an embodiment of the present invention;

FIG. 2 is a view of a “Top Menu” screen;

FIG. 3 is a view of a “User Registration (1)” screen;

FIG. 4 is a view of a “User Registration (2)” screen;

FIG. 5 is a view of a “User Registration (3)” screen;

FIG. 6 is a view of an image of a confirmation E-mail;

FIG. 7 is a view of a “User Registration Information Modification (1)” screen;

FIG. 8 is a view of a “User Registration Information Modification (2)” screen;

FIG. 9 is a view of a “User Registration Information Modification (3)” screen;

FIG. 10 is a view of an image of a confirmation E-mail;

FIG. 11 is a view of a “Making Report/Album (1)” screen;

FIG. 12 is a view of a “Making Report/Album (2)” screen;

FIG. 13 is a view of a “Making Report/Album (3)” screen;

FIG. 14 is a view of a “Making Report/Album (4)” screen; 20 FIG. 15 is a view of a “Making Report/Album (5)” screen;

FIG. 16 is a view of a “Making Report/Album (6)” screen;

FIG. 17 is a view of a “Making Report/Album (7)” screen;

FIG. 18 is a view of a “Making Report/Album (8)” screen;

FIG. 19 is a view of a “Template Selection” screen;

FIG. 20 is a view of a “Making Report/Album (9)—Page Edition” screen;

FIG. 21 is a view of a “Text Input” screen;

FIG. 22 is a view of a “Photo Selection” screen;

FIG. 23 is a view of a “Preview” screen;

FIG. 24 is a view of a “Making Report/Album (10)” screen;

FIG. 25 is a view of a “Making Report/Album (11)” screen;

FIG. 26 is a view of an “Order Sheet (1)” screen;

FIG. 27 is a view of an “Order Sheet (2)” screen;

FIG. 28 is a view of an “Order Sheet (3)” screen;

FIG. 29 is a view of an “Order Sheet (4)” screen;

FIG. 30 is a view of an image of an order confirmation E-mail;

FIG. 31 is a view of an “Order Confirmation (Final Confirmation) (1)” screen;

FIG. 32 is a view of an “Order Confirmation (Final Confirmation) (2)” screen;

FIG. 33 is a view of an “Order Confirmation (Final Confirmation) (3)” screen;

FIG. 34 is a view of a “Making Report/Album (11)” screen;

FIG. 35 is a flow chart showing an information flow between a user terminal 5 and a editing system 1;

FIG. 36 is a flow chart showing the information flow between the user terminal 5 and the editing system 1, subsequent to FIG. 35;

FIG. 37 is a flow chart showing the information flow between the user terminal 5 and the editing system 1, subsequent to FIG. 36;

FIG. 38 is a flow chart showing the information flow between the user terminal 5 and the editing system 1, subsequent to FIG. 37;

FIG. 39 is a flow chart showing the information flow between the user terminal 5 and the editing system 1, subsequent to FIG. 38;

FIG. 40 is a flow chart showing the information flow between the user terminal 5 and the editing system 1, subsequent to FIG. 39;

FIG. 41 is a flow chart showing the information flow between the user terminal 5 and the editing system 1, subsequent to FIG. 40;

FIG. 42 is a flow chart showing the information flow between the user terminal 5 and the editing system 1, subsequent to FIG. 41;

FIG. 43 is a flow chart showing the information flow between the user terminal 5 and the editing system 1, subsequent to FIG. 42;

FIG. 44 is a flow chart showing the information flow between the user terminal 5 and the editing system 1, subsequent to FIG. 43;

FIG. 45 is a flow chart showing the information flow between the user terminal 5 and the editing system 1, subsequent to FIG. 44;

FIG. 46 is a flow chart showing the information flow between the user terminal 5 and the editing system 1, subsequent to FIG. 45;

FIG. 47 is a flow chart showing the information flow between the user terminal 5 and the editing system 1, subsequent to FIG. 46;

FIG. 48 is a flow chart showing the information flow between the user terminal 5 and the editing system 1, subsequent to FIG. 47;

FIG. 49 is a flow chart showing the information flow between the user terminal 5 and the editing system 1, subsequent to FIG. 48;

FIG. 50 is a flow chart showing the information flow between the user terminal 5 and the editing system 1, subsequent to FIG. 49;

FIG. 51 is a flow chart showing the information flow between the user terminal 5 and the editing system 1, subsequent to FIG. 50;

FIG. 52 is a flow chart showing the information flow between the user terminal 5 and the editing system 1, subsequent to FIG. 51;

FIG. 53 is a flow chart showing the information flow between the user terminal 5 and the editing system 1, subsequent to FIG. 52;

FIG. 54 is a block diagram of a system according to another embodiment of the present invention;

FIG. 55 is a view of a “Registered Image List” screen;

FIG. 56 is a view of a “Making Report/Album (9)—Photo Selection” screen which additionally displays an image on the local/WWW; and

FIG. 57 is a flow chart showing the information flow between the user terminal 5 and the editing system 1, as a substitution for FIG. 48.

### DESCRIPTION OF THE PREFERRED EMBODIMENT

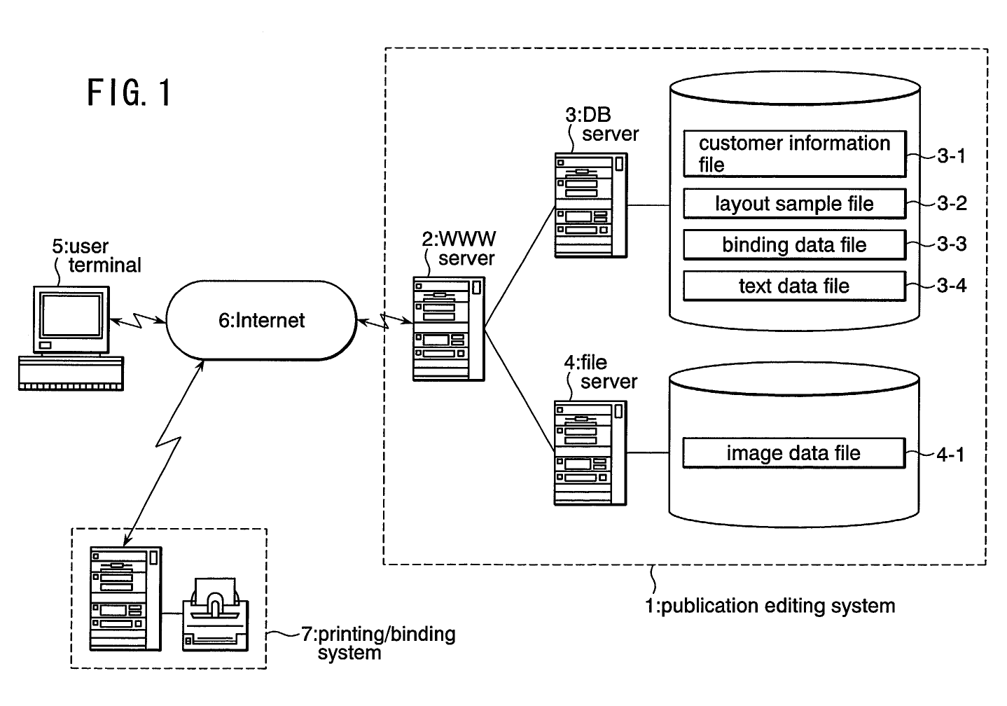

With reference to the drawings, an embodiment of the present invention will now be described. FIG. 1 is a block diagram showing a publication editing system according to one embodiment of the invention. An editing system 1 according to the present invention includes a WWW server 2, a database server 3 (hereinafter referred to as “DB server”), and a file server 4. The WWW server 2 is connected with the DP server 3 and the file server 4 to mutually communicate about necessary information. The WWW server 2 includes a program execution means for executing a template display means and a text input means. With the template display means and the text input means, the WWW server 2 provides a site placing a Web page for executing an simplified publication editing function by use of a template according to the present invention (hereinafter referred to as “Edit Web site”) to a specific URL (Uniform Resource Locator) on the WWW of the Internet 6.

The editing system 1 is connected with a user terminal 5 via the Internet 6. The user terminal 5 includes an access means for accessing the Internet to access the editing system 1 via the Internet 6. A result of accessing the editing system 1 from the user terminal 5 is output from the editing system 1 to the user terminal 5 through a WWW browser installed in the user terminal 5. Inputs from the user terminal 5 to the editing system 1 are accepted through the WWW browser and transmitted to the editing system 1 via the Internet 6 by the access means. It is apparent that the WWW server 2 and the user terminal 5 may be connected with each other via any suitable network other than the Internet 6.

A publication to be edited by the editing system 1 can be readily edited on the WWW browser operable on the user terminal 5 according to an wizard-type operation scheme with a template having a combined arrangement of an image area and a text area, which are provided for displaying a selected image from a plurality of images registered in advance, such as photographic pictures, and for displaying an input text, respectively. In the editing system 1, a data of selectable images, templates and the like are stored not in the user terminal but in the editing system 1, as described later. Thus, on the side of the user terminal 5, a high-quality publication can be readily produced only by inputting required items according to the template provided by the Edit Web site through the WWW browser without using the DTP application software. This provides a unique advantage in convenience superior to any prior arts. Particularly, the editing system 1 is suitable for producing publications, such as reports, albums or the like, including an image, such as photographic pictures, therein.

The DB server 3 includes a database for managing a customer information file 3-1, a layout sample file (or a template data storage means) 3-2, a binding data file 3-3, and a text data file 3-4. The customer information file 3-1 contains customer information, such as name, street address, E-mail address, and password, on registered users of the Edit Web site. The layout sample file 3-2 contains a data of template formats having various patterns different in the arrangement of the image area and text area. The binding data file 3-3 contains a binding data of publications edited by the users into a complete book. While the binding data is registered as the data including only front and rear covers just after starting an editing operation, the data of each page including layout information on a text data and an image data as described later will be added in turn in the course of the editing operation. The text data file 3-4 contains a data of texts for each page of the publication, which are input into the text area of the template.

The file server 4 includes a database for managing an image data file (or an image information storage means) 4-1 containing images, such as photos, to be input into the image area of the template. These selectable images are registered in this database in advance by a user who has, for example, taken the photos. The images can be registered in the following processes. It is a first process that the user sends photographic prints taken by the user to an Edit Web site manager by post or any other suitable means, and then the Edit Web site manager converts said prints into digital information by a scanner, followed by registering in the image data file 4-1. This process is advantageous for users who have no scanner or digital camera. It is a second process that the user sends the digital information of photos obtained from a scanner input or digital camera to the Edit Web site via the network, and then the WWW server 2 registers the digital information in the image data file 4-1 managed by the file server 4. The digital information may also be sent but not shown, by attaching it to an E-mail or by using any suitable image transfer application or window activated on the user terminal 5. The registered image data can be modified from the user terminal 5 via the Internet 6 by use of an image information editing means which is executed by a program executing means incorporated in the WWW server 2.

Preferably, the user terminal 5 is a personal computer, and connected with the Internet 6 by an access means incorporated in the personal computer. The user terminal 5 includes an input means, such as a keyboard or a mouse, and an output means, such as a display. Preferably, the after-mentioned publication editing operation is performed through the WWW browser operable in the user terminal 5.

Preferably, a printing/binding system 7 is connected with the editing system 1 via a network such as the Internet 6. The printing/binding system 7 is a so-called print-on-demand system in which the printing/binding system 7 receives an electronic data of a publication, and prints and binds a required number of books based on the received data. It is preferable that the editing system 1 produces printing information for use in printing the publication based on the binding data, layout sample data, image data, and text data, by use of a printing information forming means executed by the program executing means in the WWW server 2. While the printing/binding system 7 receives the printing information from the editing system 1 preferably via the Internet 6, the printing information may otherwise be received by means of a recording medium, such as a MO disk, having the printing information stored thereon. Further, in the printing/binding system 7, the printing system and the binding system may be provided as independently separate systems.

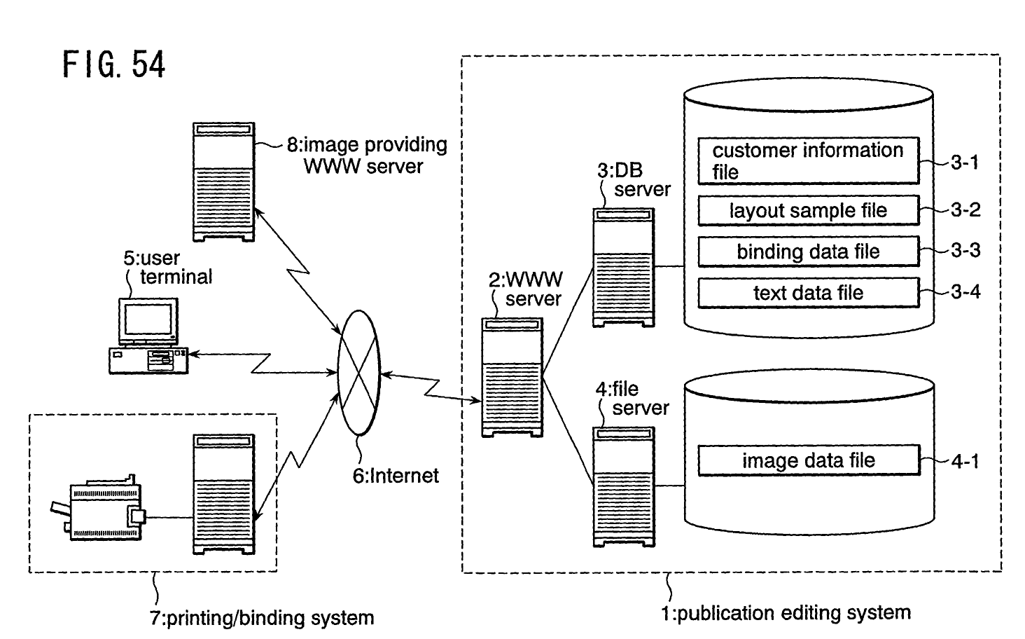

FIG. 54 is a block diagram showing one embodiment according to another aspect of the present invention. In FIG. 54, an image providing WWW server 8 linked to the Internet 6 is provided in addition to the system shown in FIG. 1. According to another aspect of the present invention, it is not always necessary to register the image information in the image data file 4-1 in advance. Specifically, if image information on an image to be displayed on the user terminal 5 when editing a publication through the user terminal 5 is stored either in the user terminal 5 or another image providing WWW server 8, the image may be acquired therefrom to display it on the user terminal. For that purpose, a file path of the image information in the user terminal 5 or a WWW address of the image providing WWW server 8 may be transmitted to the WWW server 2. Then, the WWW server 2 transmits a screen described with HTML or the like to the user terminal 5 so as to display the image information having the path or WWW address, so that the image may be displayed on the user terminal 5 without transmitting the image information itself to the user terminal 5. However, even in this case, when forming an electronic data of a publication including such image information after completion of the editing operation, the image information is necessary to be retransmitted from the user terminal 5 or the image providing WWW server 8 to the image data file 4-1.

The image-providing server 8 provides information including WWW image information. The image-providing server 8 may be any WWW server specified by the user. Any user can acquire desired image information by specifying an image providing WWW server 8 and a file address (URL) of the image information stored in the image providing WWW server 8, through his/her user terminal 5. The acquired image information may be used for editing a publication.

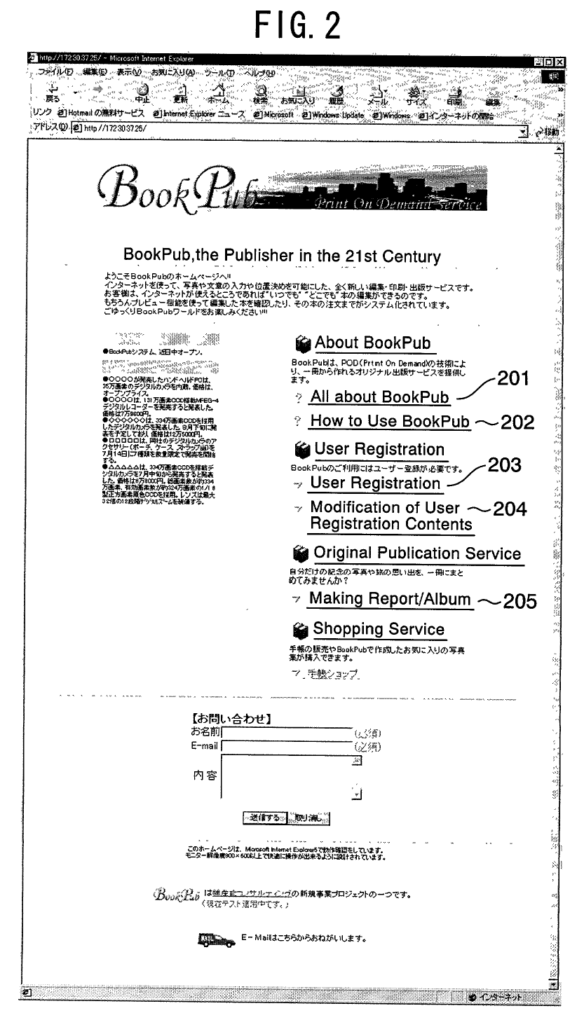

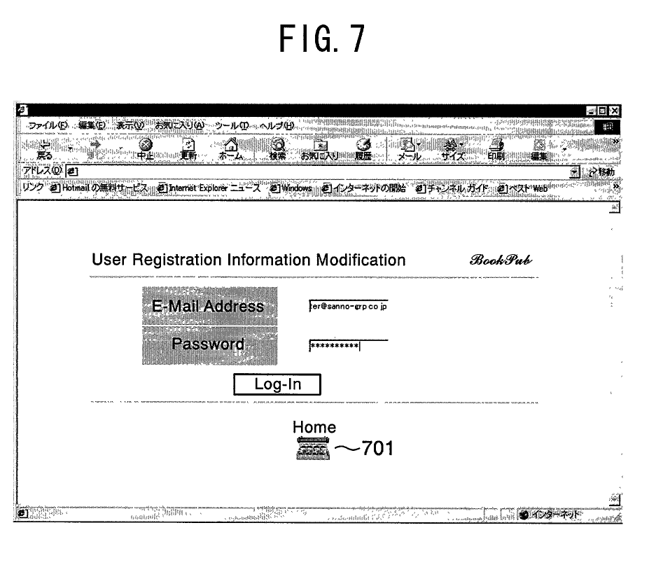

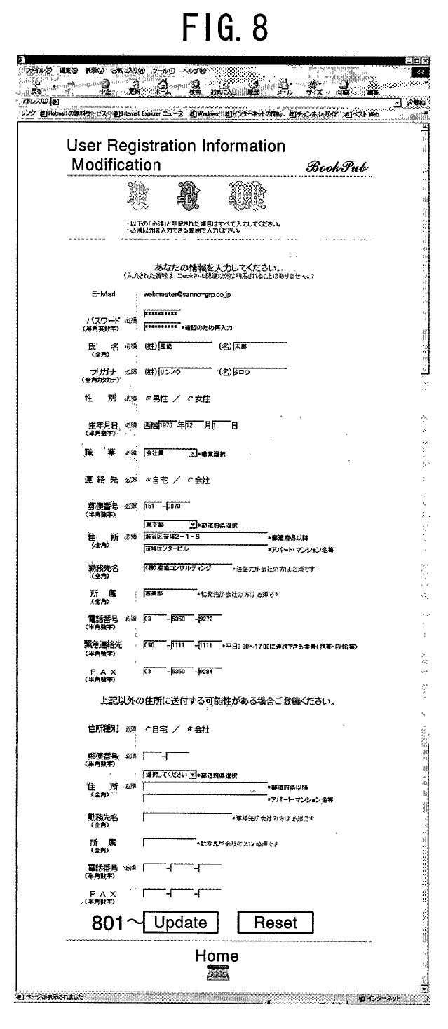

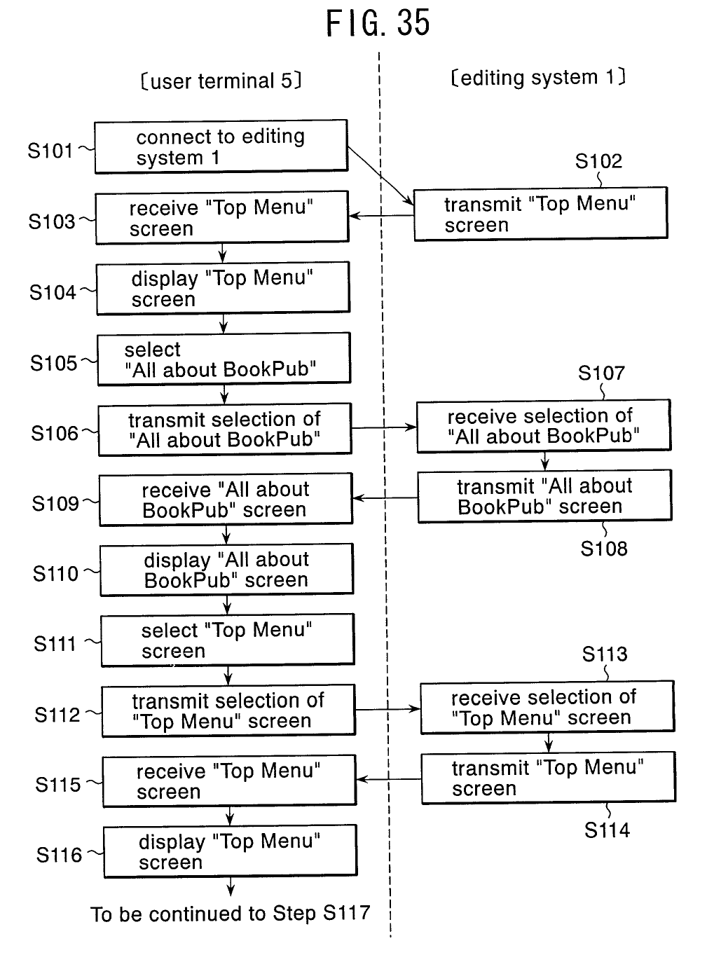

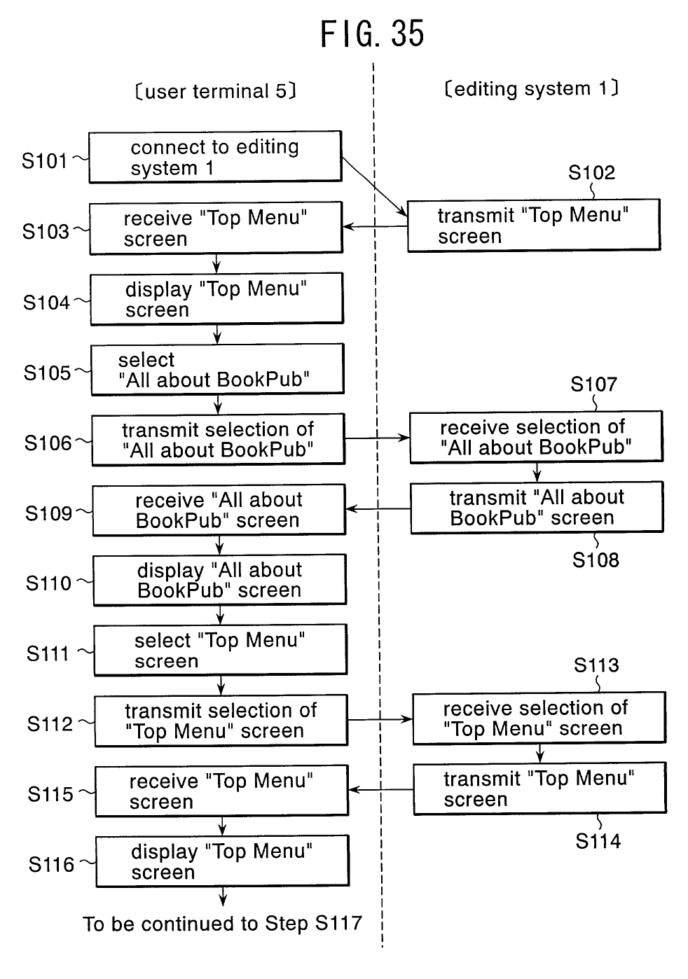

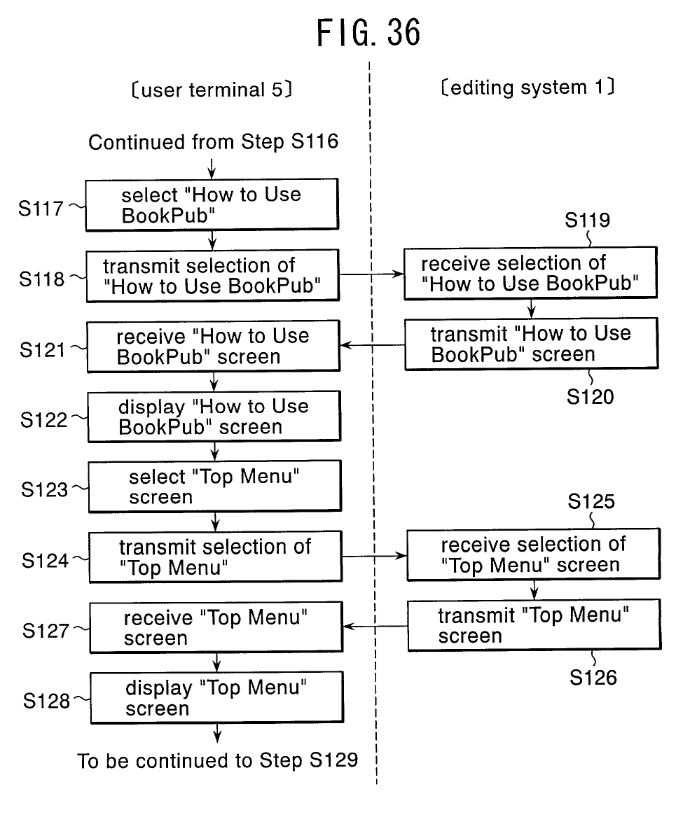

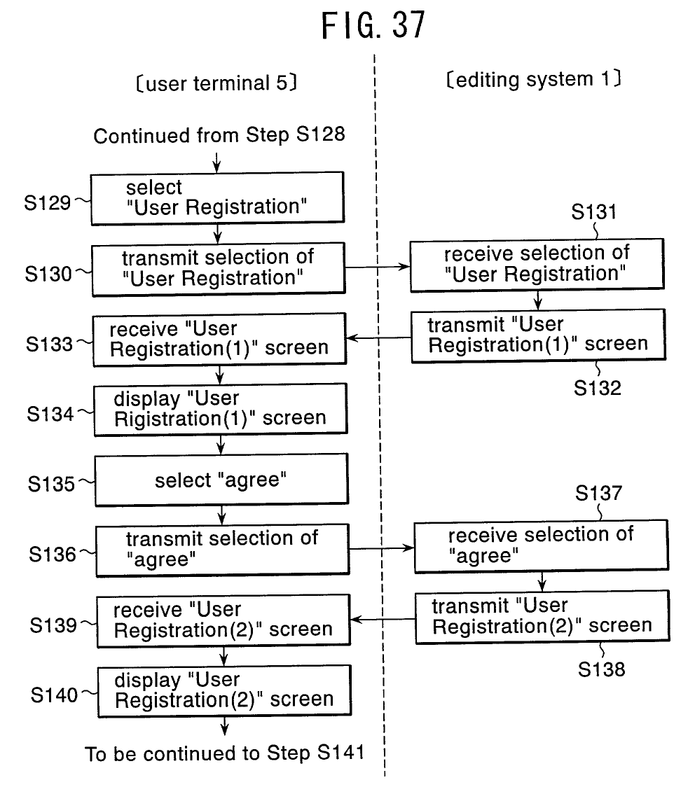

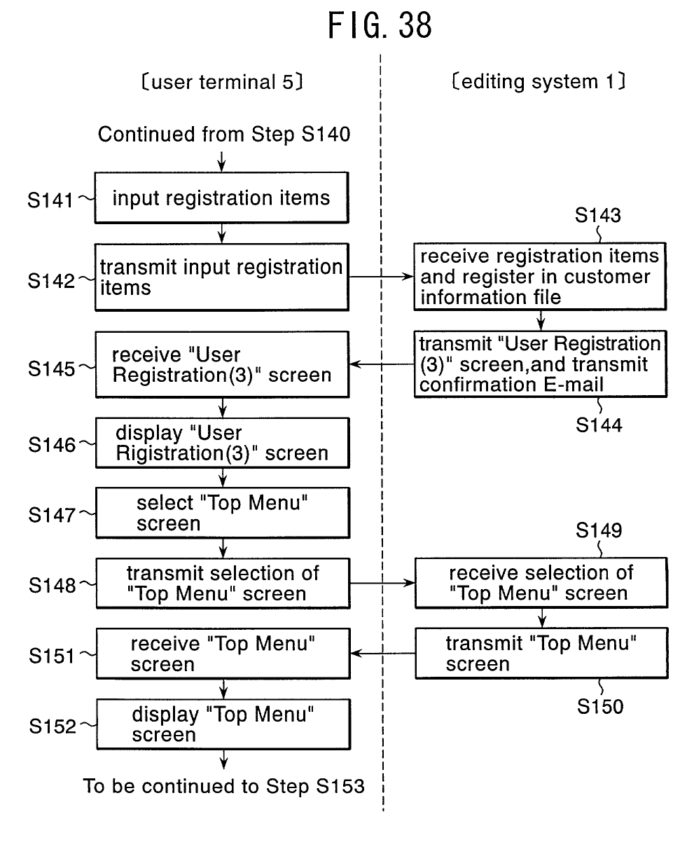

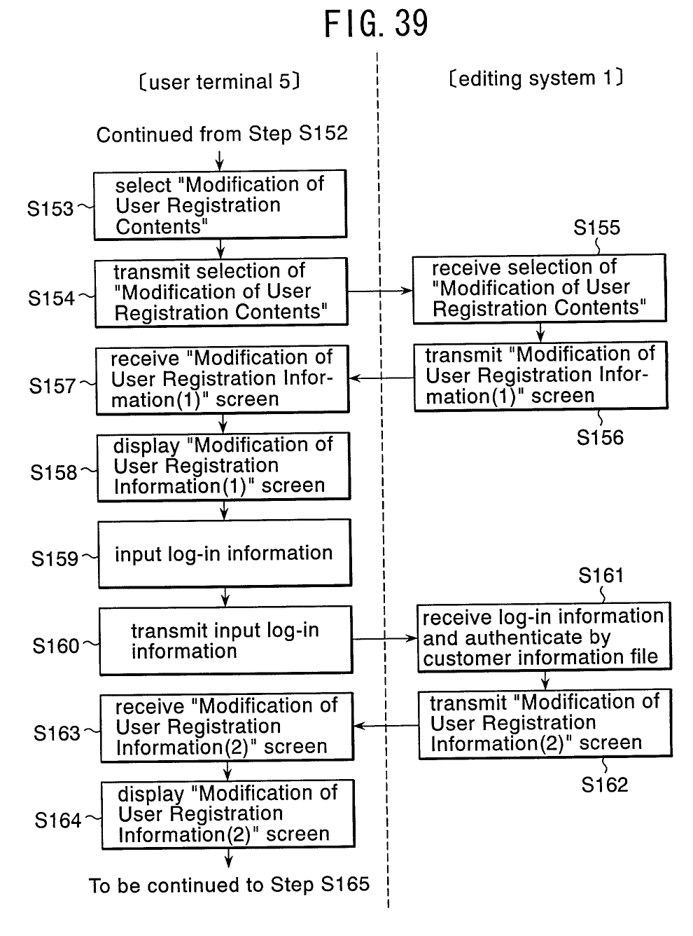

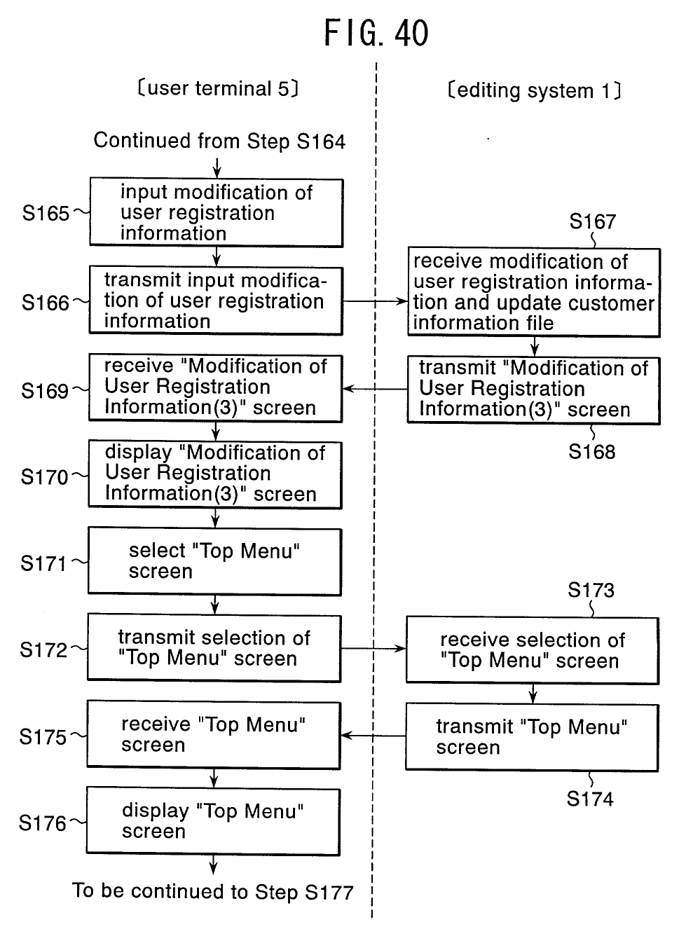

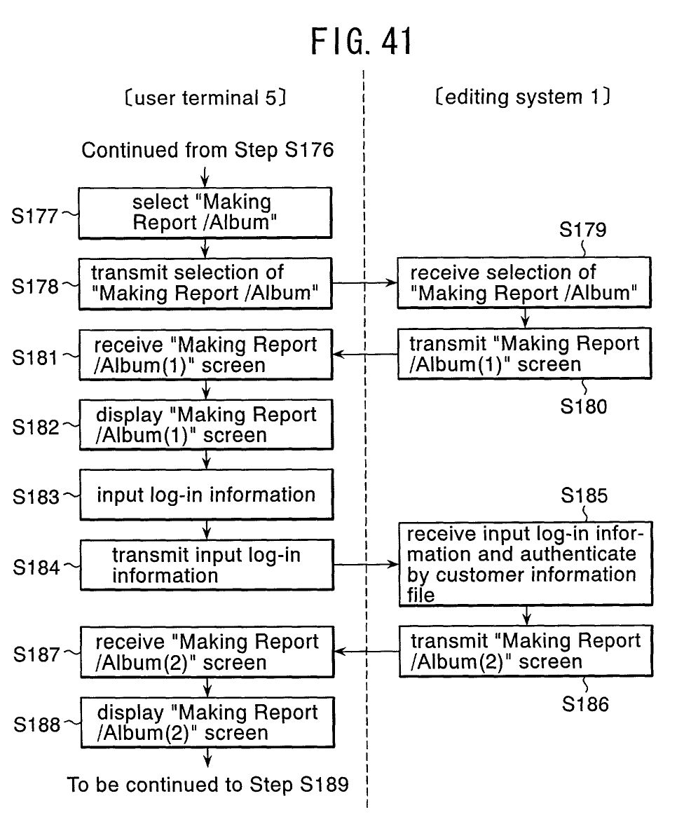

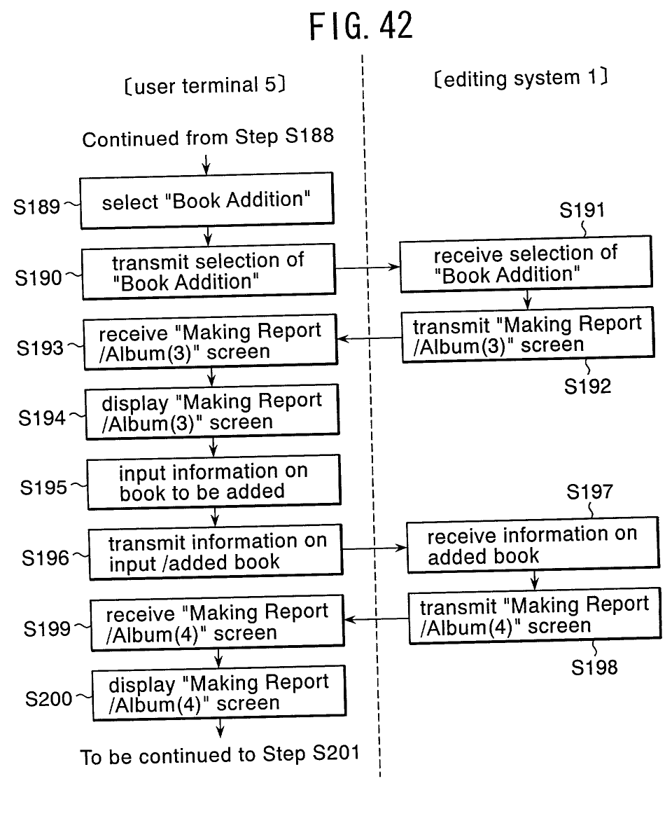

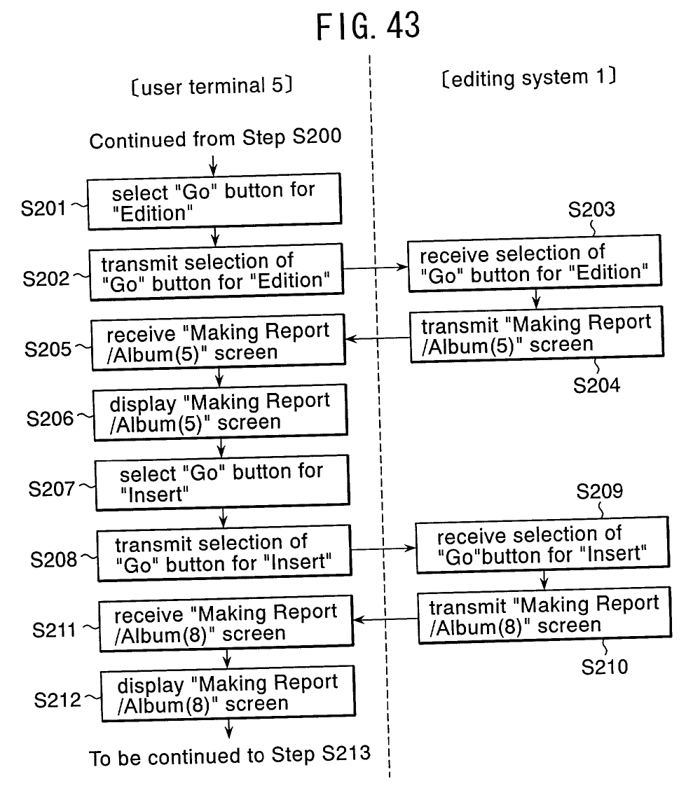

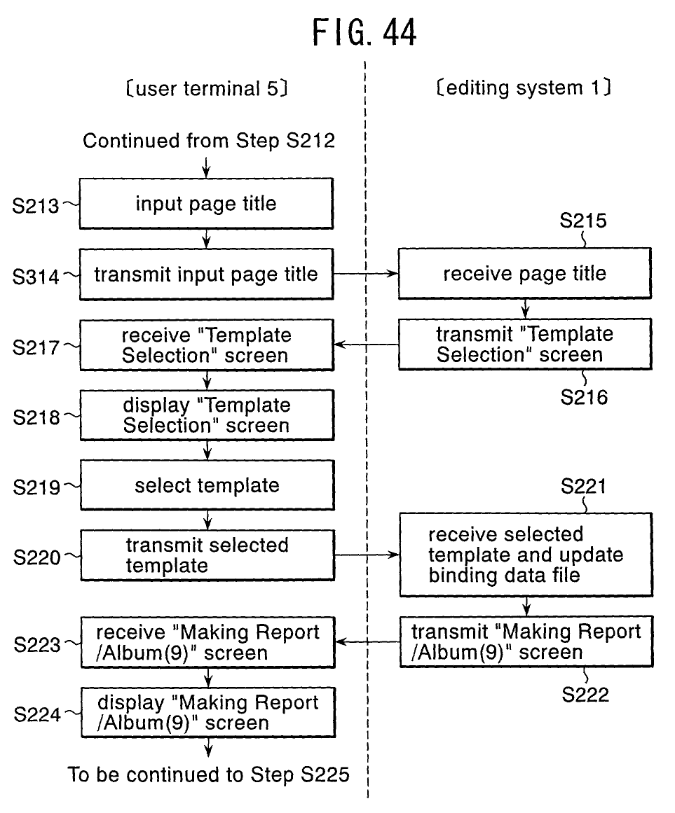

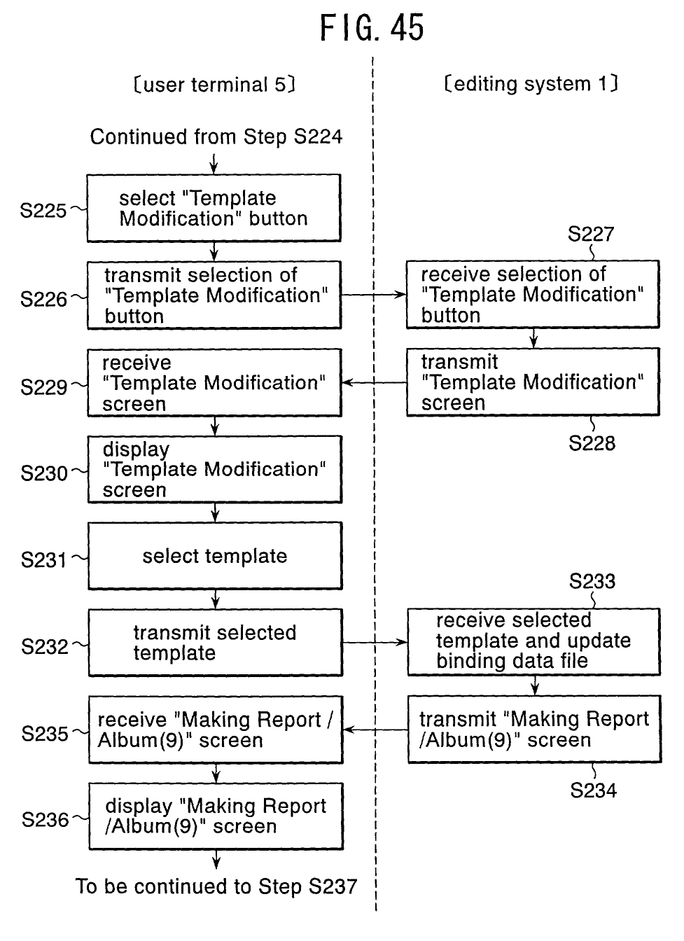

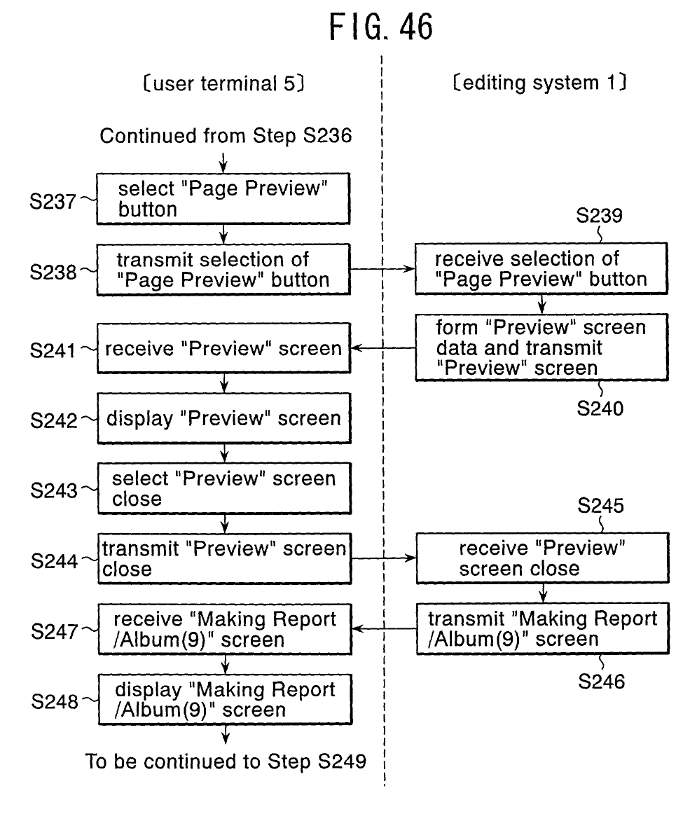

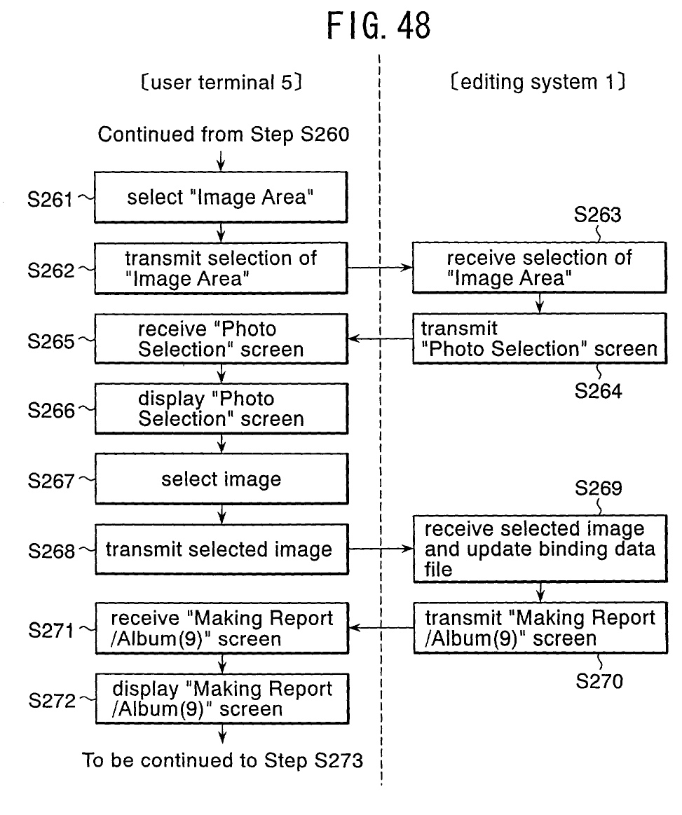

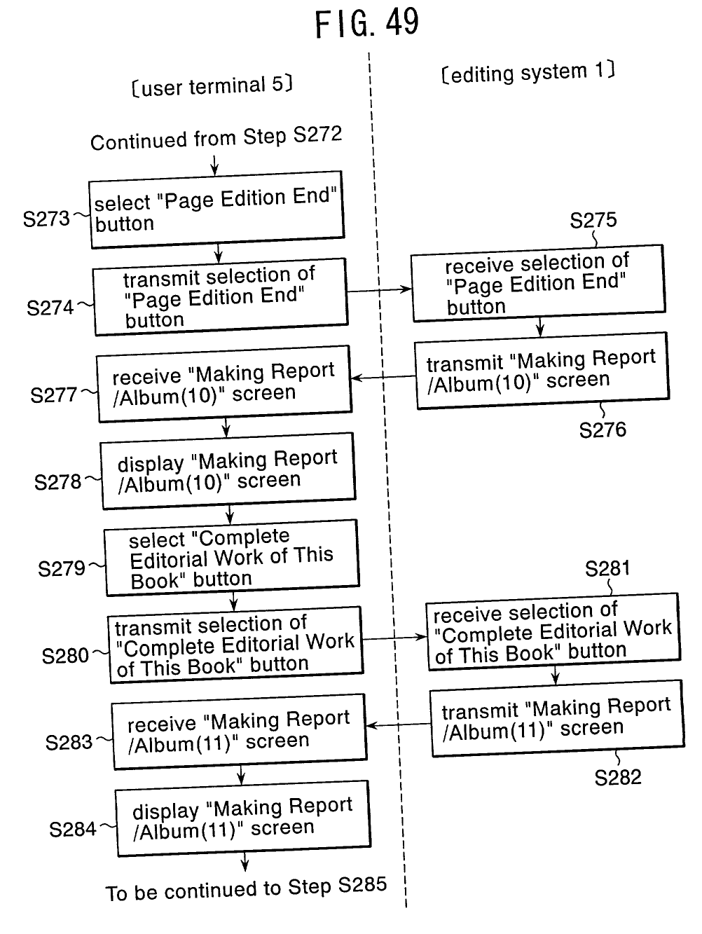

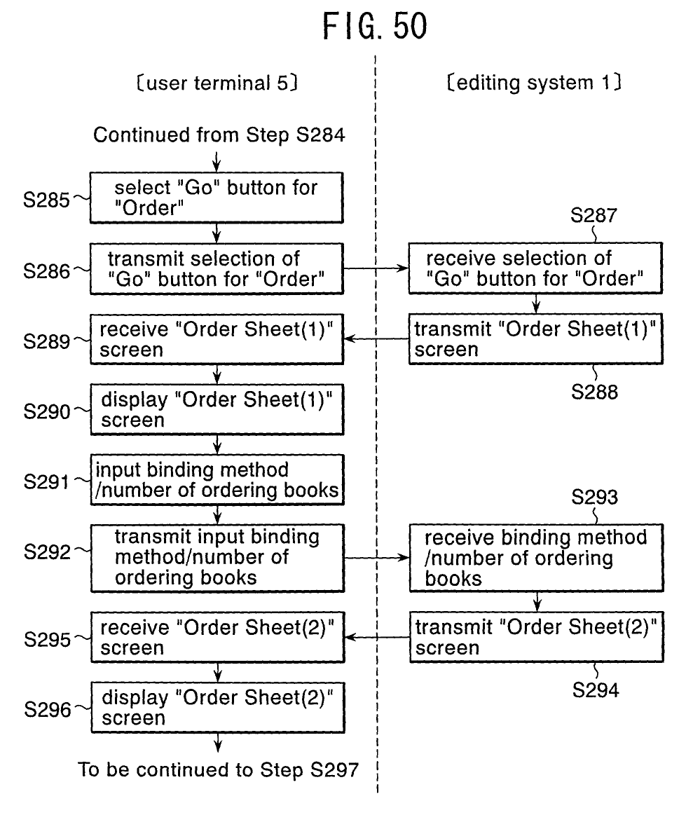

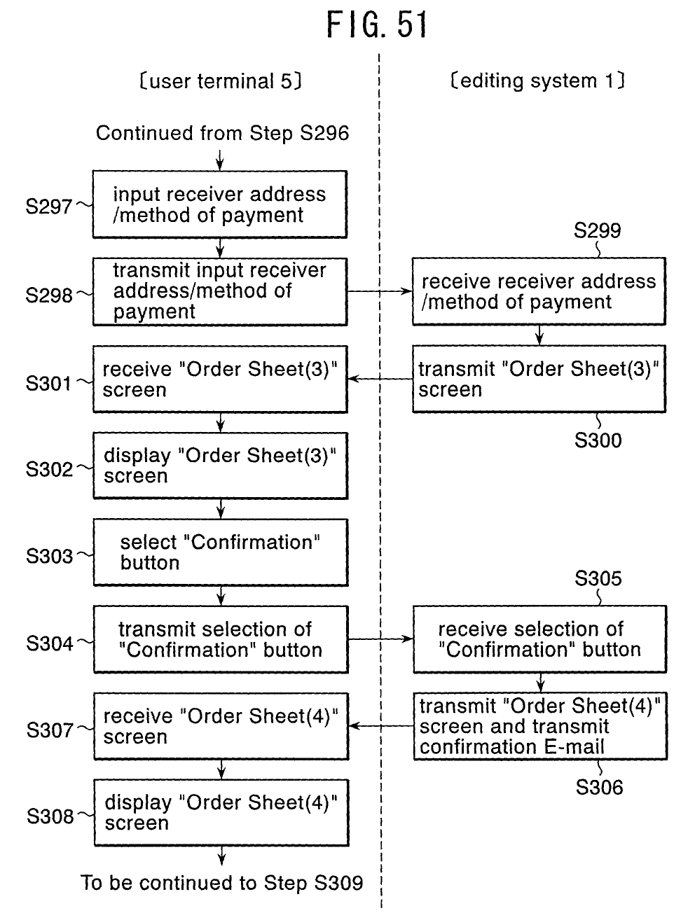

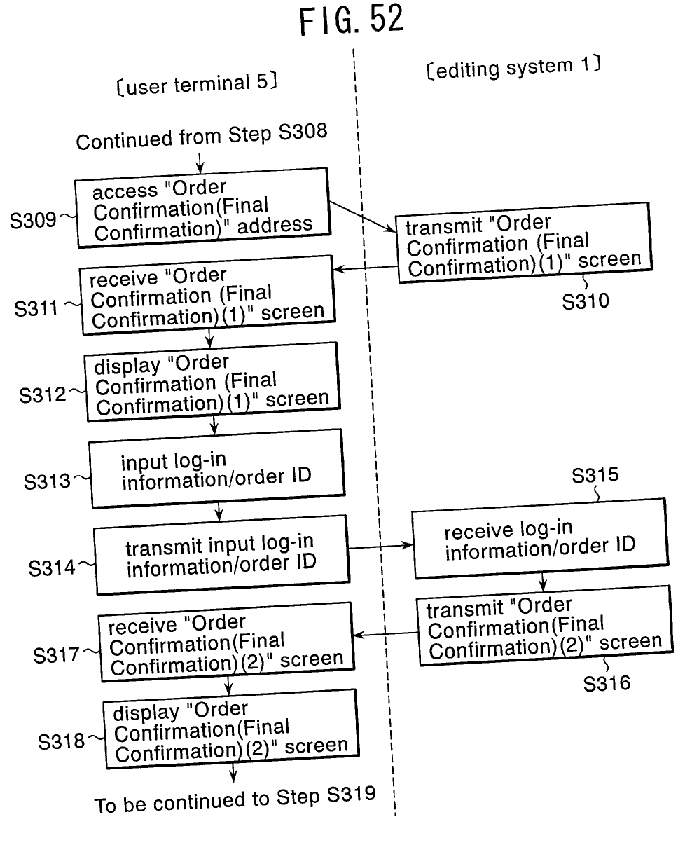

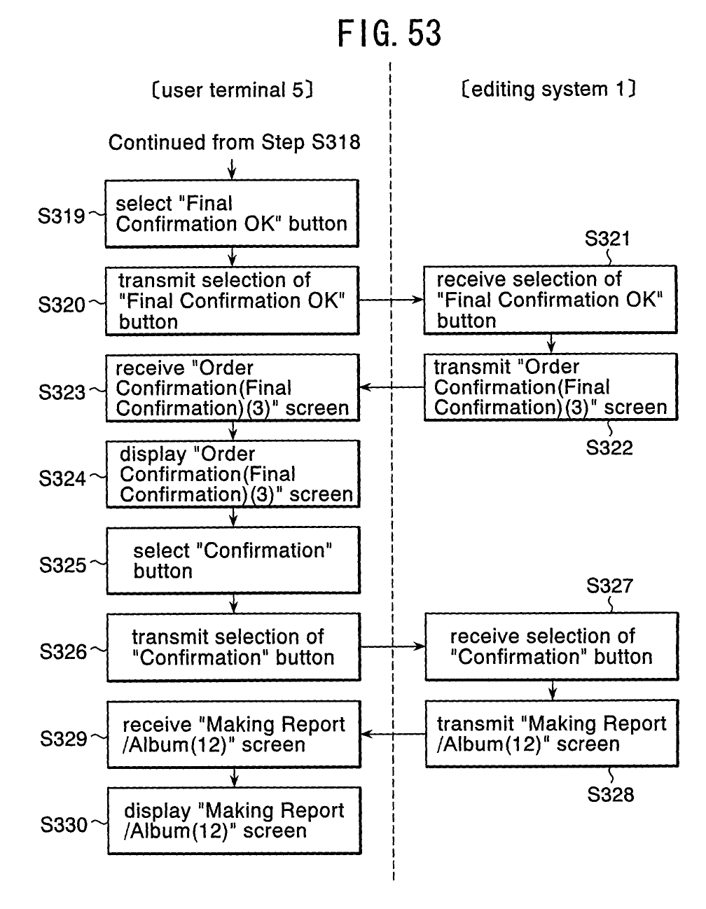

The operation of the editing system 1 according to the invention will now be described with reference to the drawings. FIGS. 2 to 34 show screens displayed on the WWW browser which is being operated on the user terminal 5 and connected with the editing system 1. FIGS. 35 to 53 show each operation of the user terminal 5 and the editing system 1, and an information flow therebetween in increments of step.

When using the publication editing system according to the present invention, the user first connects the user terminal 5 with the Web site provided by the editing system 1 according to the present invention via the Internet 6. The name of the Edit Web site provided by the editing system 1 is specified as “BookPub” (Registered Trade Mark).

Once the user terminal 5 is connected with the Edit Web site (Step S101), the editing system 1 transmits a “Top Menu” screen to the user terminal 5 (Step S102), and then the user terminal 5 receives the “Top Menu” screen (Step S103) to display the “Top Menu” screen as shown in FIG. 2 (Step S104). The user may display various screens as to introduction of the Edit Web site, user registration, order for the publishing service and others by use of the “Top Menu” screen. If a display area 201 indicated as “All about BookPub” is clicked by operating a mouse (hereinafter, referred simply as “click”) (Step S105), the user terminal 5 and the editing system 1 mutually communicate about related information (Steps S106 to S109). Then, an “All about BookPub” screen is displayed, but not shown, on the user terminal 5 to introduce features and outline of the Edit Web site (Step S110). With this “All about BookPub” screen, if the user selects the “Top Menu” screen (Step S111), the user terminal 5 and the editing system 1 mutually communicate about related information (Steps S112 to S115), and the “Top Menu” screen as shown in FIG. 2 is displayed again on the user terminal 5 (Step S116). On the “Top Menu” screen as shown in FIG. 2, if a display area 202 indicated as “How to Use BookPub” is clicked (Step S117), the user terminal 5 and the editing system 1 mutually communicate about related information (Steps S118 to S121), and then a “How to Use BookPub” screen is displayed on the user terminal 5 to introduce how to use the Edit Web site (Step 122). With this screen, if a display area indicated as “Top Menu” is selected, (Step S123), the user terminal 5 and the editing system 1 mutually communicate about related information (Steps S124˜S127), and the “Top Menu” screen is displayed again on the user terminal 5 (Step S128).

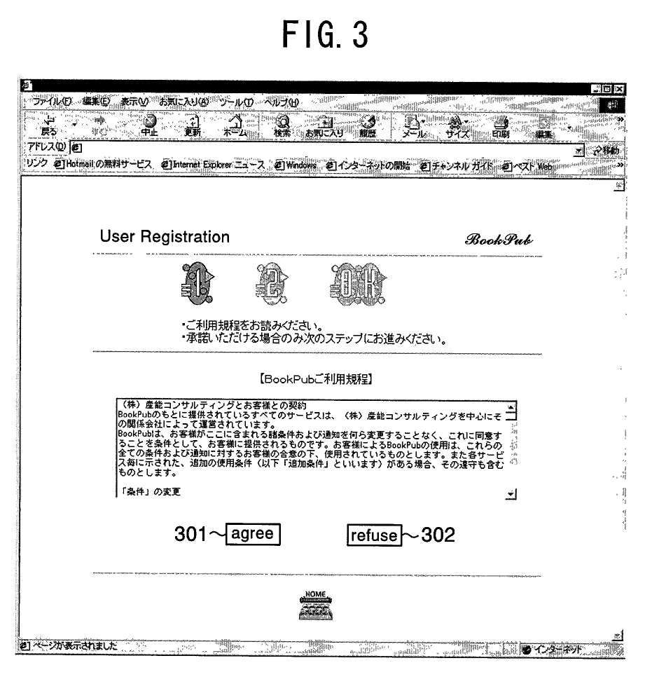

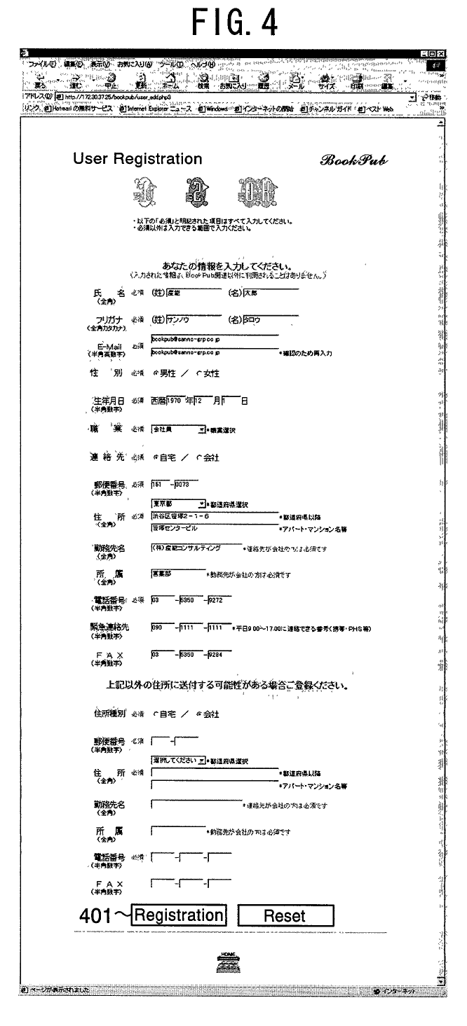

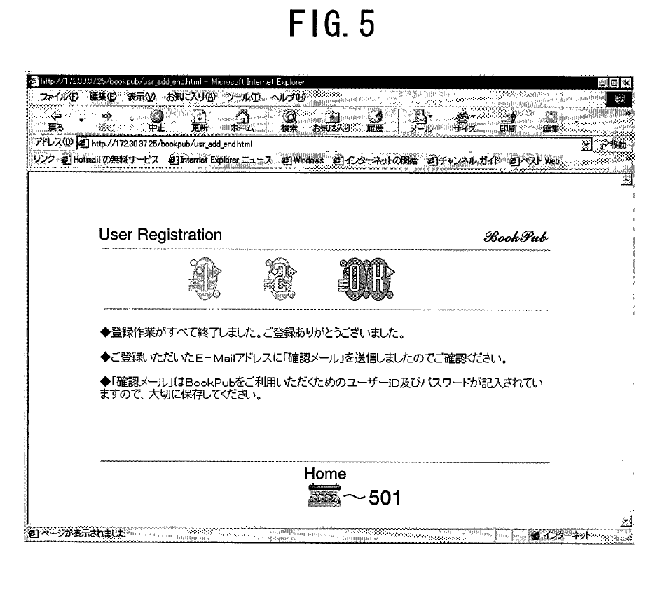

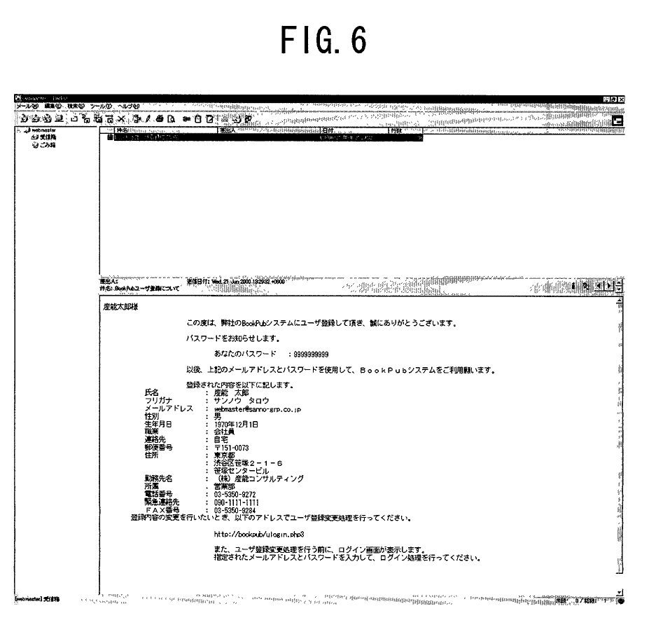

For receiving the service of the Edit Web site, any user is required to make arrangements of the user registration in advance. On the “Top Menu” screen, when a display area 203 indicated as “User Registration” is clicked (Step S129), the user terminal 5 and the editing system 1 mutually communicate about related information (Steps S130 to S133), then a “User Registration (1)” screen as shown in FIG. 3 is displayed on the user terminal 5 (Step S134). Some prescriptions for using the Edit Web site are displayed on this screen. The user may selectively click either one of an “I agree (agree)” button 301 for accepting the prescriptions or “I don't agree (refuse)” button 302 for rejecting the prescriptions. When the user clicks the “I agree” button 301 (Step S135), the user terminal 5 and the editing system 1 mutually communicate about related information (Steps S136 to S139), and then a “User Registration (2)” screen as shown in FIG. 4 is displayed on the user terminal 5 (Step S140). The user inputs required items for the user registration, such as full name, E-mail address, sexuality, birth date, residential address and others through this screen. After completing such inputs, when the user clicks a “Registration” button 401 (Step S141), the input information is transmitted from the user terminal 5 to the editing system 1 via the Internet 6 (Steps S142 and S143). Then, the WWW server 2 in the editing system 1 generates a user ID and a user password for the user. Preferably, the user E-mail address is used as the user ID as-is. This is advantageous for user because of no need for learning a new additional ID in addition to the E-mail address. Based on the input information, the WWW server 2 updates the customer information file 3-1 managed by the DB server 3 (Step S144). The editing system 1 transmits a “User Registration (3)” screen representing the completion of the user registration as shown in FIG. 5 to the user terminal 5 (Step S144), and display the screen on the user terminal 5 (Steps S145 and S146). The WWW server 2 sends an E-mail, which informs the registered contents, the user ID (or the user E-mail address) and the user password, to the user E-mail address (Step S144). As shown in FIG.6, the user may check out the E-mail by accessing own E-mail address from the user terminal 5 or any other terminals. When the user selectively clicks a “Home” button 501 to display the “Top menu” screen through the “User Registration (3)” screen as shown in FIG. 5 (Step S147), the user terminal 5 and the editing system 1 mutually communicate about related information (Steps S148 to S151), and then the “Top Menu” screen is displayed again on the user terminal 5 (Step S152).

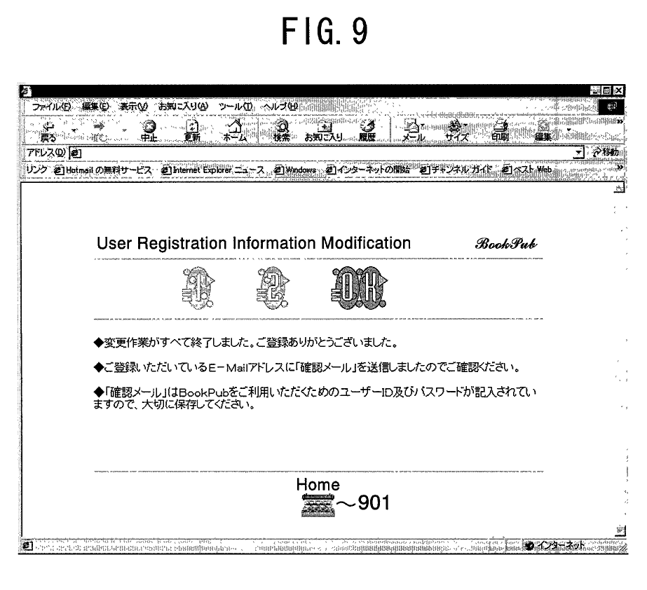

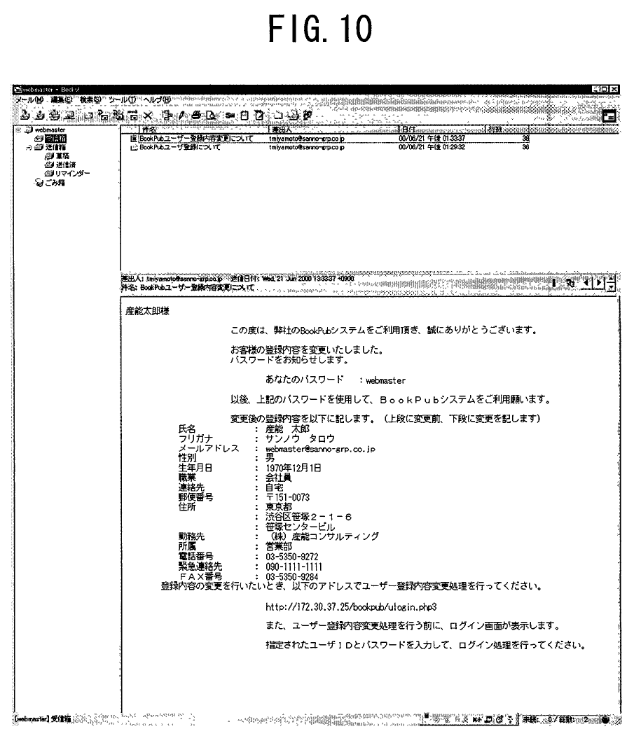

The user can modify the registered information in the following manner. When the user clicks a display area 294 indicated as “Modification of User Registration Contents” on the “Top Menu” screen as shown in FIG. 2 (Step S153), the user terminal 5 and the editing system 1 mutually communicate about related information (Steps S154 to S157), and then a “Modification of User Registration Information (1)” screen is displayed on the user terminal 5 (Step S158). When the user inputs log-in information, such as own E-mail address or password, and then clicks a “Log-in” button 701 (Step S159), the log-in information is transmitted from the user terminal 5 to the editing system 1 (Step S160). Upon receiving this information, the editing system 1 verifies the user (Step S161) based on the customers information file 3-1 managed by the DB server 3. After completing the authentication, the editing system 1 transmits a “Modification of User Registration Information (2)” screen to the user terminal 5 (Step S162), and then the “Modification of User Registration Information (2)” screen is displayed on the user terminal 5 (Steps S163 and S164). The screen indicates current registration information on the user. With this screen, the user may rewrite the registration information and input the modified information. When the user clicks an “Update” button 801 (Step S165) after completing the input, the modified information is transmitted from the user terminal 5 to the editing system 1 via the Internet 6 (Step S166). The WWW server 2 of the editing system 1 receives the modified registration information, and updates the customer information file 3-1 (Step S167) managed by the DB server 3, according to the modified registration information. The editing system 1 transmits a “Modification of User Registration Information (3)” screen, which indicates the completion of modifying the user registration information, to the user terminal 5 (Step S168). Then, the user terminal 5 receives this information (Step S169), and displays the “Modification of User Registration Information (3)” screen as shown in FIG. 9. Further, the user terminal 5 sends an E-mail to the user address (Step S168) to inform the modified contents in the user registration information. As shown in FIG. 10, the user may check out the E-mail by accessing own E-mail address from the user terminal 5 or any other terminals. When the user selectively clicks a “Home” button 901 on the “Modification of User Registration Information (3)” screen to display the “Top Menu” screen (Step S171), the user terminal 5 and the editing system 1 mutually communicate about related information (Steps S172˜S175), and then the “Top Menu” screen as shown in FIG. 2 is displayed again on the user terminal 5 (Step S176).

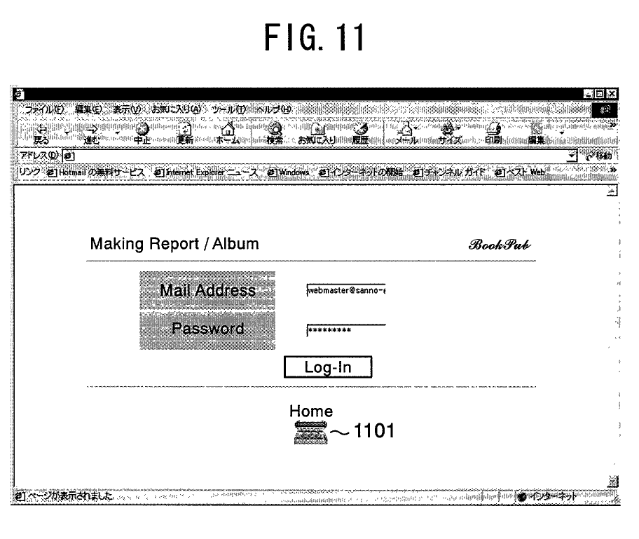

For editing and making a publication, the user may click a display area 205 indicated as “Making Report/Album” on the “Top Menu” screen as shown in FIG. 2 (Step S177). This causes a mutual communication about related information between the user terminal 5 and the editing system 1 (Steps S178˜S181), and then a “Making Report/Album (1)” screen for login as shown in FIG. 11 is displayed on the user terminal 5 (Step S182). The user may input log-in information composed of own E-mail address doubling as the user ID and password through this screen, and then clicks a “Log-In” button 1101 (Step S183). The input log-in information composed of own E-mail address doubling as the user ID and password is then transmitted from the user terminal 5 to the editing system 1 (Step S184). Upon receiving this information, the editing system 1 verifies the user based on the customer information file 3-1 managed by the DB server 3 (Step S185).

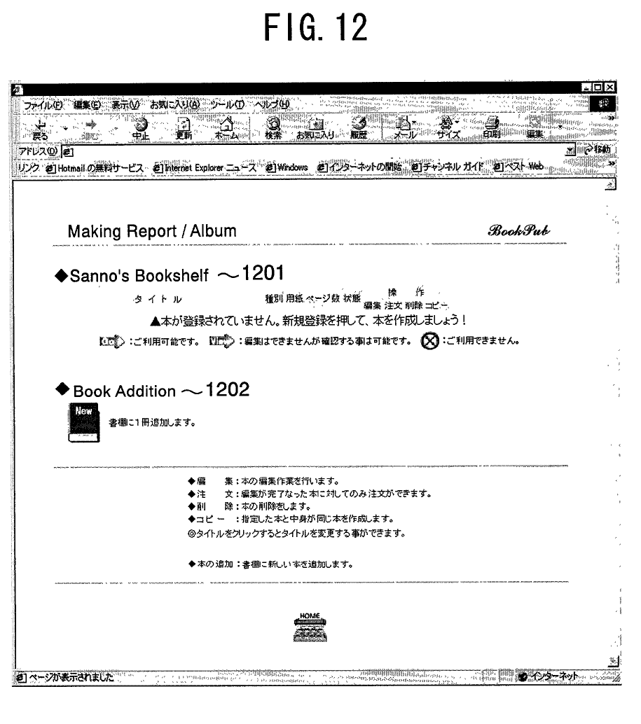

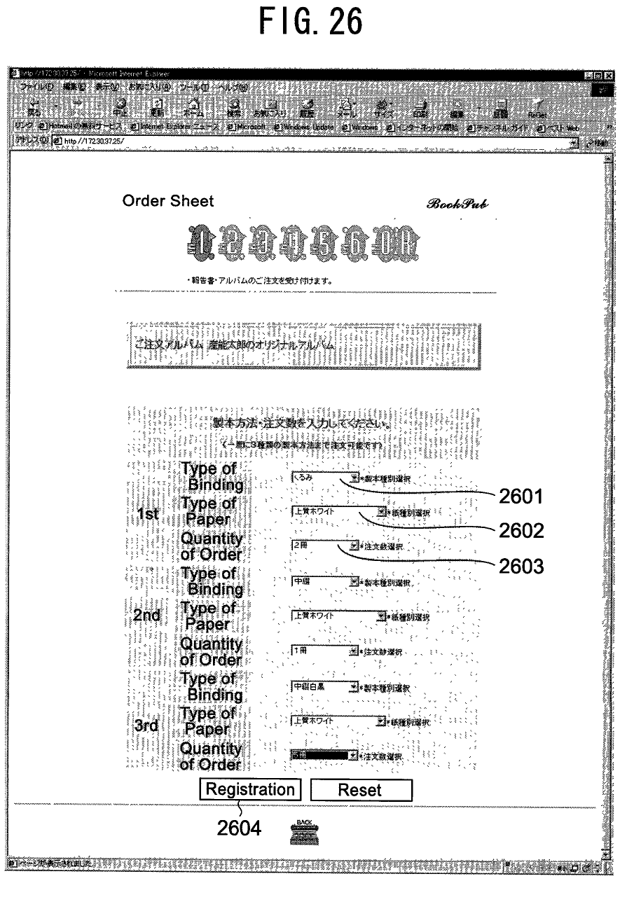

After completing the user authentication, the editing system 1 transmits a “Making Report/Album (2)” screen to the user terminal 5 (Step S186), and the “Making Report/Album (2)” screen as shown in FIG. 12 is then displayed on the user terminal 5 (Steps S187˜S188). On this screen, a list of user publication which are under the editing operation and have already been completed is displayed at the lower section of a display area 1201 indicated as a “Sanno's Bookshelf” (in the example of FIG. 12, “User” is indicated as the name of “Sanno”). In the example of FIG. 12, any publication is not displayed. However, when some publication under the editing operation is displayed, the user may selectively click one “Go” button corresponding to either one of operations related to the publication, i.e. “Edit”, “Order”, “Delete” and “Copy”, which are displayed on the “Making Report/Album (2)” screen, to perform the selecting operation to the publication, as described later. If the “Edit” is selected, a “Making Report/Album (5)” screen as shown in FIG. 15 is displayed, and the user may perform the editing operation for the publication through this screen, as described later. If the “Order” is selected, an “Order Sheet” screen as shown in FIG. 26 is displayed on the user terminal 4, and the user may place an order for bound publications through this screen, as described later. If the “Delete” is selected, the selected publication is deleted. If the “Copy” is selected, a publication having the same contents as that of the selected publication is produced. Thus, the user may modify the copied publication to make a new publication added with modifications or additions to the copied original publication.

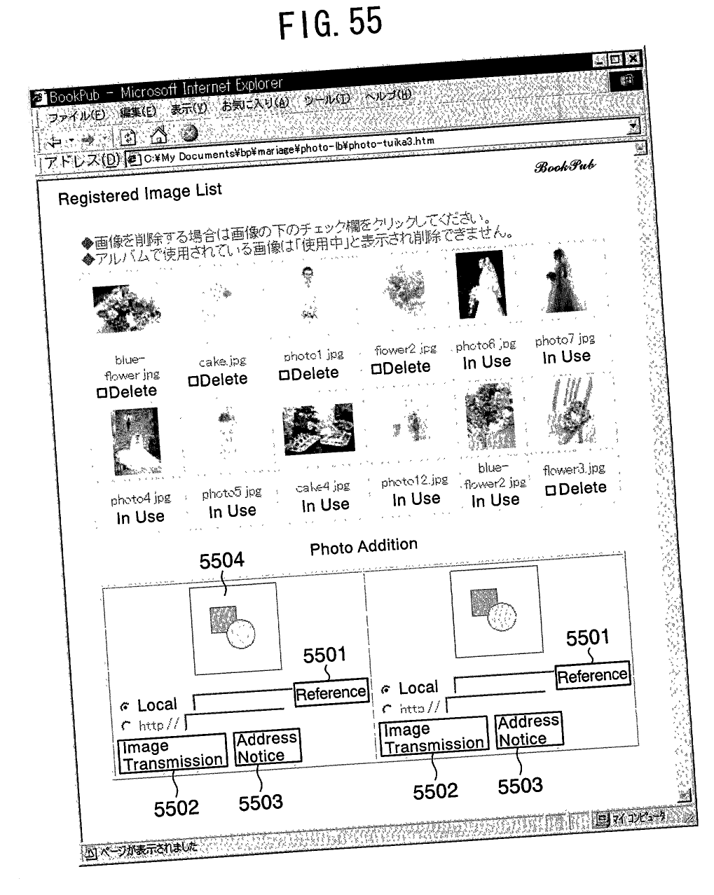

Before starting an editing operation for the publication, the user may display a list of images, which have already been registered as the image information in the image data file 4-1, on the user terminal 5 to check out them. According to another aspect of the present invention, the user may also newly register another image information in the image data file 4-1 on-line. For that purpose, the user may appropriately operate the user terminal 5 to make the editing system 1 construct a “Registered Image List” screen as shown in FIG. 55 and display it on the user terminal 5. The upper column of the “Registered Image List” screen indicates a “Photo Library” representing the images registered as the image information in the image data file 4-1 in the form of thumbnail image or the like. A file name of the image is indicated at the bottom of each image. An indication “In Use” is displayed at the bottom of the images which are currently being used in the publication. An indication “Delete” button is displayed at the bottom of the images which are currently not being used, and the user may delete these image by selecting the corresponding “Delete” button. The lower column of said “Registered Image List” screen also indicates a “Photo Addition” for inputting and registering additional images. Such additional images may be added into the image data file 4-1 by selecting from any “local” image information stored in the user terminal 5 or any image information on the WWW, stored in image providing WWW server 8.

In order to register the local image information in the image data file 4-1, a “Local” radio button may be selected to input a certain file path through an input column. When selecting a “Reference” bottom 5501, an image presented by the image information corresponding to the input file path is displayed in the display area 5504 above the input column, the user may then check out the displayed image. When the “List of Registration Images” screen is described with HTML, the above operation can be executed by describing with the Java Script to access the file corresponding to the input path and display the corresponding image. When an “Image Transmission” button 5502 is selected, the image information is transmitted from the user terminal 5 to the file server 4 via the WWW server 2, and the image data is then stored in the image data file 4-1. Thus, the image may be added into the “Photo Library”. On the other hand, when an “Address Notice” button 5503 is selected, the image information itself is not transmitted but the information on the input path is transmitted to the WWW server 2. In this case, the WWW server 2 does not store the image information in the image data file 4-1, but can display the image corresponding to the image information on the user terminal 5 in the editing operation of a publication as described later. When the “List of Registration Images” screen is described with HTML, the above operation may be achieved by transmitting a screen described with the HTML from the WWW server 2 to the user terminal 5 so as to allow the user terminal 5 to access the file corresponding to the input path in the user terminal 5 and display the corresponding image. In this case, since the image information having a large amount and file size is not transmitted from the WWW server 2 to the user terminal 5, the time required for the communication in transmitting the screen may be significantly shortened. This provides quick response and enhanced operational performance. In addition, when the image information is transmitted from the user terminal 5 to the WWW server 2 by selecting the “Image Transmission”, it is preferable to transmit the input path information at the same time. This allows the image represented by the corresponding image information to be displayed on the user terminal 5 in the editing operation without transmitting the image information from the WWW server 2 as with the aforementioned case of the “Address Notice”, even if the image information is stored in the image data file 4-1.

In order to register image information on the WWW in the image data file 4-1, an “http://” radio button is selected to input a WWW address (URL) of the image information file within the image providing WWW server 8 through an input column. When a “Reference” button 5501 is selected, an image presented by the input WWW address is displayed in a display area 5504 above the input column. Thus, the user may check out the displayed image. If the “List of Registration Images” screen is described with HTML, the inputs for requesting, receiving and displaying the image information file corresponding to the input WWW address may be described with HTML to execute the above operation. When the “Image Transmission” button 5502 is selected, the corresponding WWW address is transmitted from the user terminal 5 to the WWW server 2. Then, the WWW server 2 request and receive the image information file corresponding to the received WWW address to/from the image-providing server 8, and stores the received image information file in the image data file 4-1. In this case, the image information may be transmitted from the user terminal 5 to the WWW server 2. Thus, the image information may be added into the “Photo Library”. If the “Address Notice” button 5503 otherwise is selected, the information on the input WWW address is transmitted to the WWW server 2. As with the case of the aforementioned “Local” image information, the WWW server 2 can display the image presented in the after-mentioned publication editing operation by to the image information on the user terminal 5, even if the image information is not stored in the image data file 4-1.

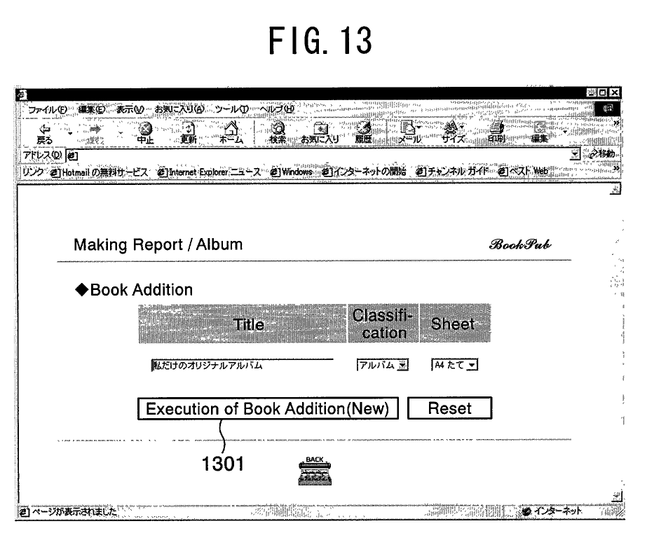

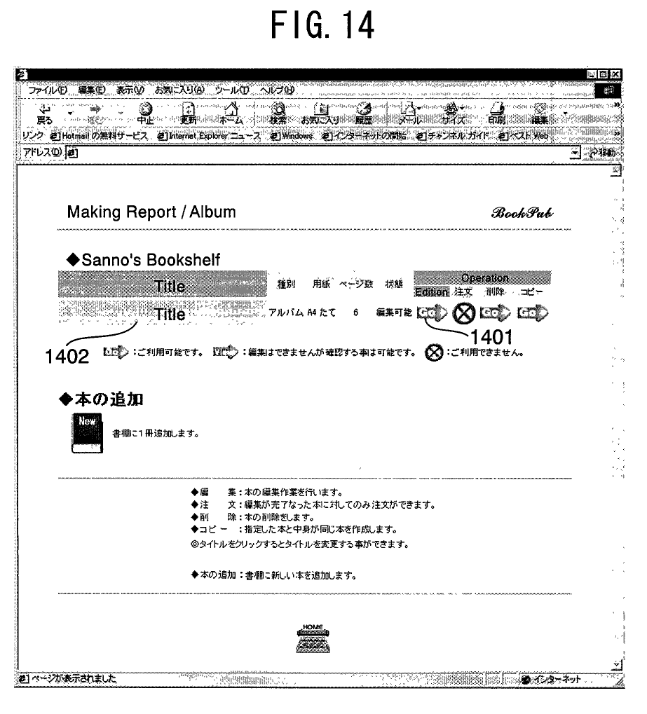

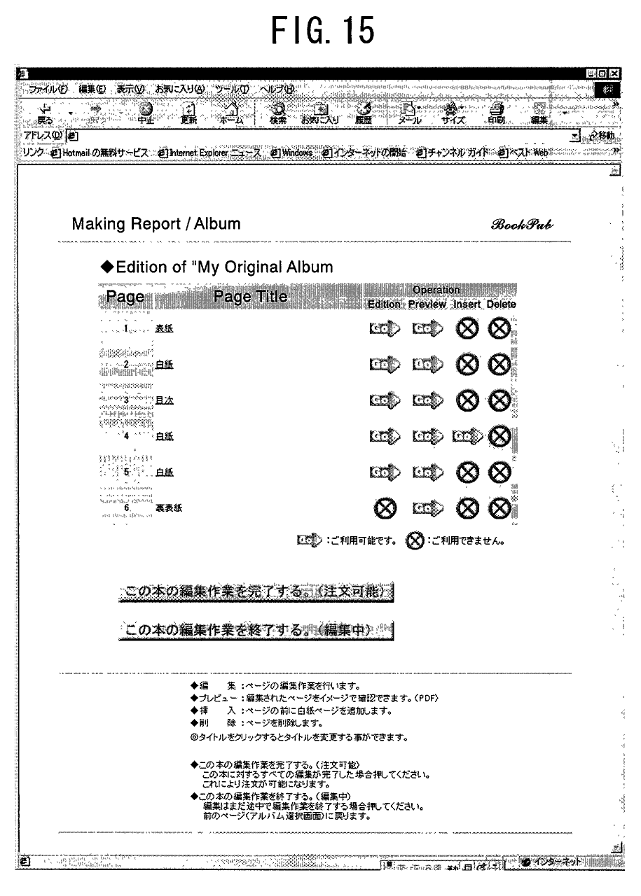

For making a new publication, the user may click a display area 1202 indicated as “Book Addition” as shown in FIG. 12 (Step S189). Then, the user terminal 5 and the editing system 1 mutually communicate about related information (Steps S190 to S193), and a “Making Report/Album (3)” screen is displayed on the user terminal 5 (Step S194). The user may input a “Title”, “Classification”, and “Sheet” for the publication through this screen. As to the “Classification” or “Sheet”, a pull-down menu with a selectable list is displayed by clicking a corresponding “▾” button. The user may selectively input a desired item by selecting from the displayed list. In the example of FIG. 13, the “Title”, “Classification” and “Sheet” are “My Original Album”, “Album” and “A4, lengthwise”, respectively. After completion the input, when the user clicks an “Execution of Book Addition (New)” button 1301 (Step S195), the user terminal 5 and the editing system 1 mutually communicate about related information (Steps S196˜S199), and a “Making Report/Album (4)” screen as shown in FIG. 14 is displayed on the user terminal 5 (Step S200). This screen indicates the publication added by the above operation, titled “My Original Album”, in the column of “Sanno's Bookshelf”. In this screen, “Album” and “A4, lengthwise” are also indicated for the “Classification” and “Sheet”, respectively, as specified in the publication adding operation as described above. The “Making Report/Album (4)” screen also includes “Page Number”, and “State” representing the availability for the editing operation. Further, this screen indicates “Operation” buttons composed of “Edition”, “Order”, “Delete”, and “Copy”. If these operations are executable for the publication, a corresponding “Go” button is indicated, while if not, a corresponding “x” buttons is indicated.

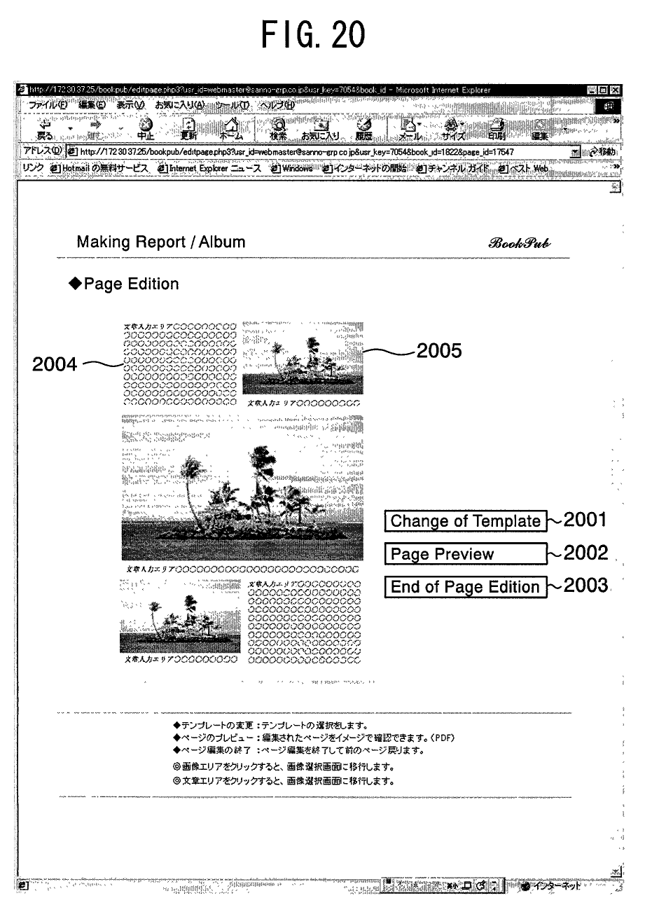

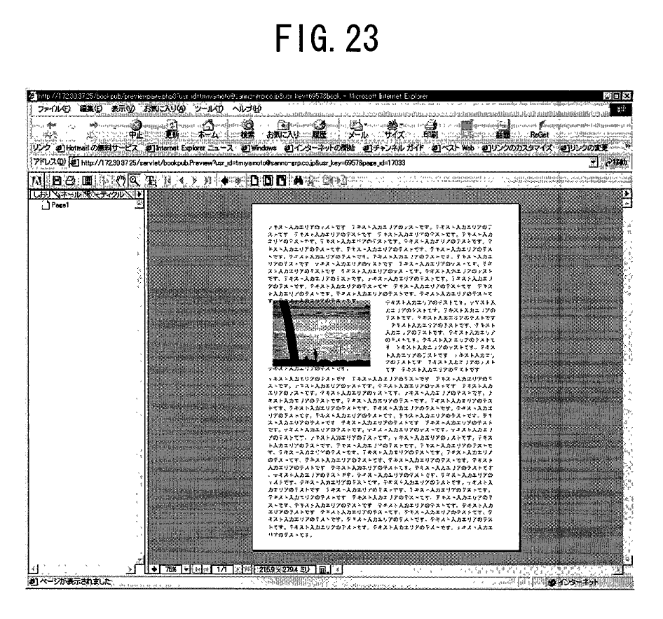

In the screen of FIG. 14, when the “Go” button 1401 for the “Edition” in the “Operation” column is clicked (Step S201), the user terminal 5 and the editing system 1 mutually communicate about related information (Steps S202˜S205), and a “Making Report/Album (5)” as shown in FIG. 15 is displayed on the user terminal 5 (Step S206). In this screen, “Operation” buttons composed of “Page Number” “Page Title”, “Edition”, “Preview”, “Insert” and “Delete” are indicated for each page of the publication (“Go” button or “x ” button is indicated depending on the availability of each operation). The user may shift to any desired page of the publication by clicking the “Page Title”. Furthermore, the user may execute any desired operation for each page by clicking the “Go” button corresponding to each operation. For example, if the user clicks the “Go” button for the “Edition”, a “Making Report/Album (9)—Page Edition” screen as shown in FIG. 20 is displayed on the user terminal 5 to allow the user to edit the page as described later. If the user clicks the “GO” button for the “Preview”, a “Preview” screen as shown in FIG. 23 is displayed to allow the user to check out the image of the edited page. If the user clicks the “GO” button for the “Insert”, a blank page is added as a preceding page to the current page. If the user clicks the “GO” button for the “Delete”, the page is deleted.

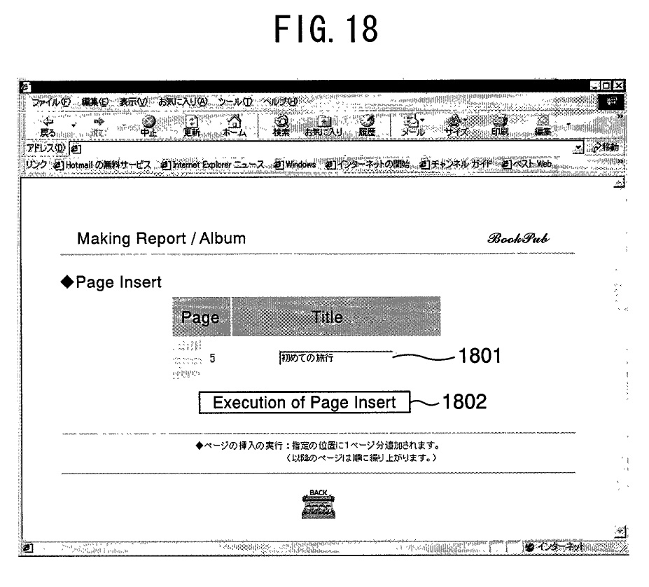

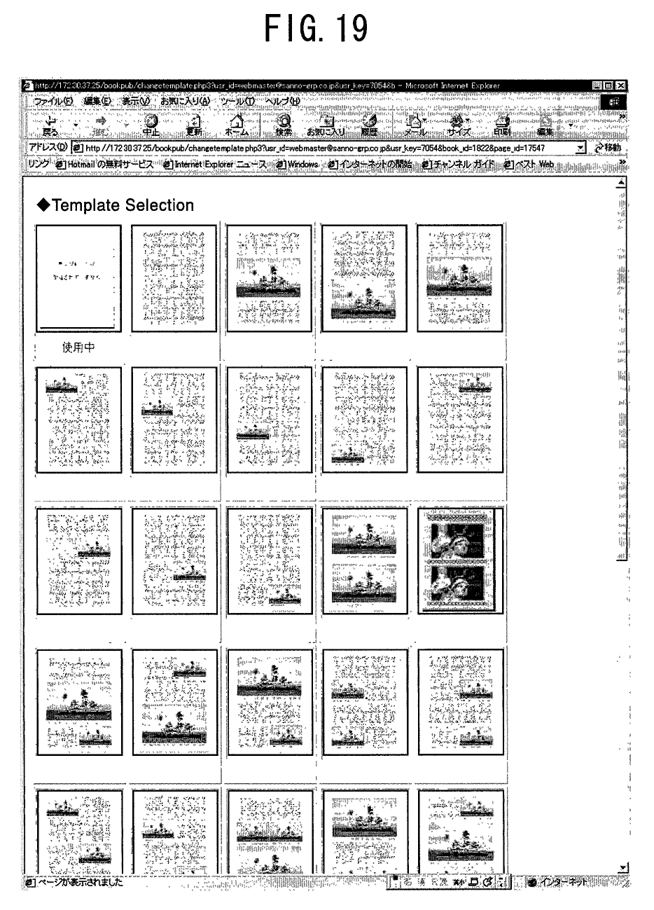

When the user clicks the “Go” button for the “Insert” (Step S207), the user terminal 5 and the editing system 1 mutually communicate about related information (Steps S208 to S211), and a “Making Report/Album (8)” screen as shown in FIG. 18 is displayed on the user terminal 5 (Step S212). When the user inputs a page title through the “Title” inputs area 1801 (Step S213) and then clicks an “Execution of Page Insert” button 1802 (Step S214), a page corresponding to the input page title is inserted (Step S215). Then, the editing system 1 transmits a “Template Selection” screen to the user terminal 5 (Step S216) based on the data from the layout sample file 3-2 managed by the DB server 3. Then, the user terminal 5 receives it (Step S217), and displays the “Template Selection” screen as shown in FIG. 19 (Step S218). The template is a basic format for a page image and composed of an image area and a text area.

By use of the template, the user selects a desired image to be input into the image area and inputs a text to be added to the text area to make a page in an image according to the basic format of the template, as described later. To each page is necessarily assigned a specific type of template. The template to be used may be selected by clicking it on the screen (Step S219). The user terminal 5 transmits the information on the selected template to the editing system 1 (Step S220), and the editing system 1 receives the information to updates the binding data file 3-3 corresponding to the publication, which is managed by the DB server 3, based on the received information (Step S221). The editing system 1 transmits the “Making Report/Album (9)—Page Edition” screen to the user terminal 5 (Step S222). Then, the user terminal 5 receives the screen (Step S223) to display the “Making Report/Album (9)—Page Edition” screen as shown in FIG. 20 (Step S224). The user may edit each page through the screen as described later.

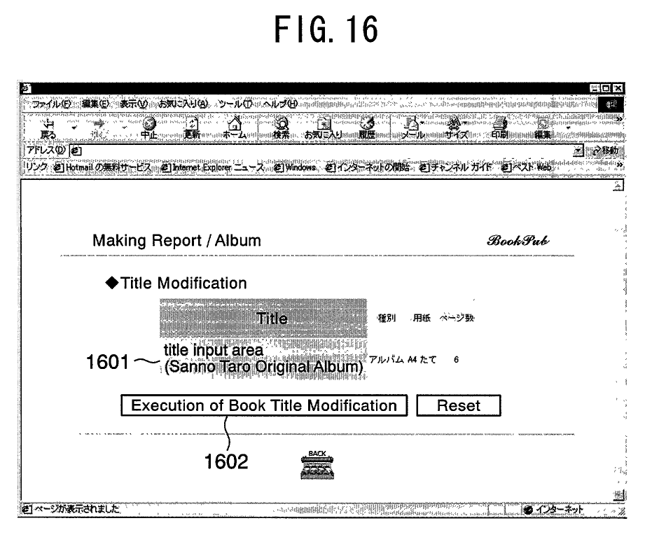

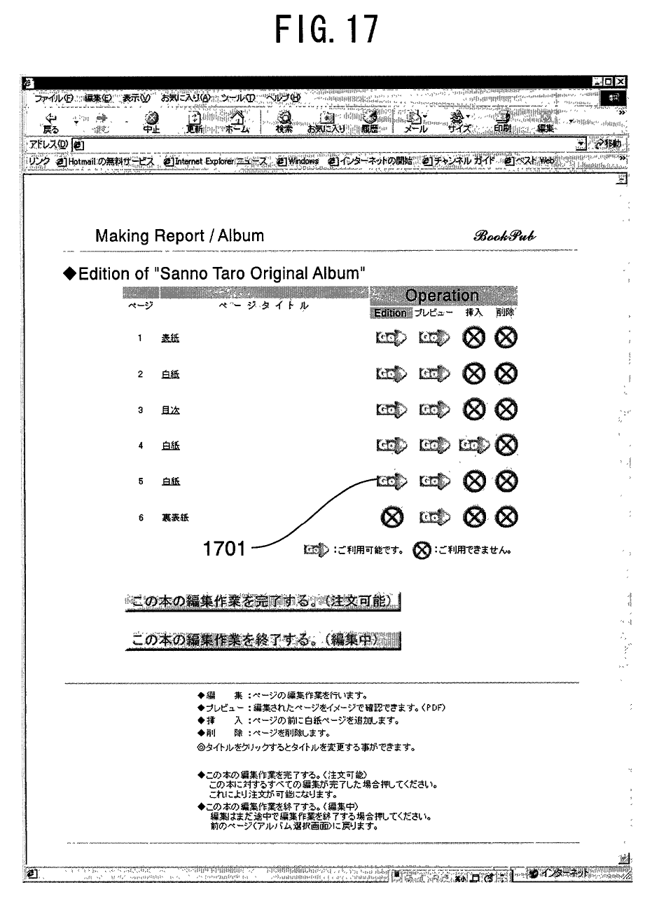

In the screen of FIG. 14, when a “Title” display area 1402 is clicked, a “Making Report/Album (6)” screen is displayed on the user terminal 5. By inputting a modified title through a title input area 1601 and then clicking a “Execution of Book Title Modification” button 1602, the user may modify the title of the publication. In the example of FIG. 16, the title of the publication is changed to “Sanno Taro Original Album”. By this operation, the “Making Report/Album (7)” screen as shown in FIG. 17 for the publication having the modified title is displayed on the user terminal 5. The example of FIG. 17 shows a displayed screen for editing an album entitled “Sanno Taro Original Album”. The information of the modified title is transmitted from the user terminal 5 to the WWW server 2, and the binding data file 3-3 corresponding to the publication managed by the DB server 3 is updated based on the transmitted information.

With the screen in FIG. 17, when the “Go” button 1701 for the “Edition” in the “Operation” column is clicked, the “Making Report/Album (9)—Page Edition” screen as shown in FIG. 20 is displayed on the user terminal 5. This screen indicates the image area and text area, which are arranged according to the format of the selected template. If there is a selected image or input text, this is displayed in the corresponding area. In FIG. 20, the area displaying birds corresponds to the image area, while the area filled with a number of marks “◯” corresponds to the text area.

The operation to be performed on the screen as shown in FIG. 20 will be now described. In the screen of FIG. 20, when a “Change of Template” button 2001 is clicked (Step S225), the user terminal 5 and the editing system 1 mutually communicate about related information (Steps S226 to S229), and then a “Selection of Template” screen as shown in FIG. 19 is displayed on the user terminal 5 (Step S230). The user may click and select a desired template (Step S231). The information of the selected template is transmitted from the user terminal 5 to the editing system 1 (Step S232). The editing system 1 receives this information and updates the binding data file 3-3 for the subject publication managed by the DB server 3 (Step S233), based on the received information. The editing system 1 transmits the “Making Report/Album (9)—Page Edition” screen to the user terminal 5 (Step S234), and the user terminal 5 receives this information (Step S235) to display the “Making Report/Album (9)—Page Edition” screen as shown in FIG. 20 (Step S236).

In the screen of FIG. 20, when a “Page Preview” button 2002 is clicked (Step S237), the user terminal 5 and the editing system 1 mutually communicate about related information (Steps S238˜S241), and then a “Preview” screen as shown in FIG. 23 is displayed on the user terminal 5 (Step S242). The “Preview” screen is a page image converted into the PDF format based on the binding data for the edited publication managed by the DB server 3, and is approximate to a corresponding printed-out image. Thus, the user may readily check up the appearance of a corresponding finished publication provided by an after-mentioned printing/binding service. Preferably, the page image in the form of PDF to be displayed in the “Preview” screen has a lower amount of information or a smaller file size than the corresponding image data managed by the file server 4, for example, by lowering resolution. This provides a reduced number of bytes of data to be transmitted from the WWW server 2 to the user terminal 5, which allows the “Preview” screen to be displayed more quickly on the user terminal 5. Thus, an excellent operational performance may be achieved. However, if the page image in PDF format displayed in the “Preview” screen is printed out from a printer connected with the user terminal 5, the quality of the printed page image is slightly inferior to that of the corresponding printed page image from the publication information stored in the WWW server 2. This strongly motivates users to use the after-mentioned printing/binding service provided by the Edit Web site, instead of printing the publication edited through the Edit Web site by a printer connected with the user terminal 5 to bind the copies. When selecting a “Exit” for the “Preview” screen (Step S243), the user terminal 5 and the editing system 1 mutually communicate about related information (Steps S244 to S247), the “Making Report/Album (9)—Page Edition” screen as shown in FIG. 20 is displayed again on the user terminal 5.

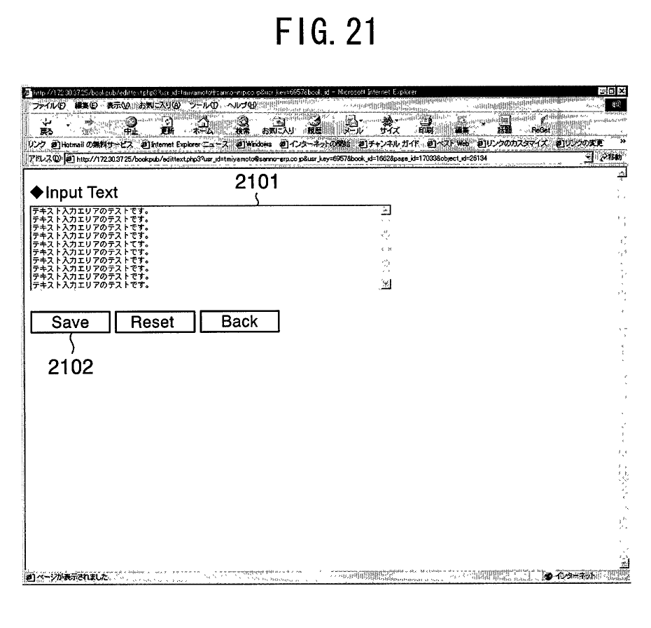

In the screen of FIG. 20, when the user clicks a certain area for inputting texts, for example, a text area 2004 (Step S249), the user terminal 5 and the editing system 1 mutually communicate about related information (Steps S250˜S253), and then a “Text Input” screen as shown in FIG. 21 is displayed on the user terminal 5 (Step S254). This screen includes a text input area 2101 through which the user may input a text. After completing the input of the text, when the user clicks a “Save” button 2102 (Step S255), the user terminal 5 transmits the input text to the editing system 1 (Step S256). The editing system 1 receives said text to update the text data file 3-4 corresponding to the subject publication managed by the DB server 3 (Step S257), based on the received text. The editing system 1 transmits the “Making Report/Album (9)—Page Edition” screen to the user terminal 5 (Step S258). The user terminal 5 receives the screen (Step S259) to display the “Making Report/Album (9)—Page Edition” screen as shown in FIG. 20 (Step S260).

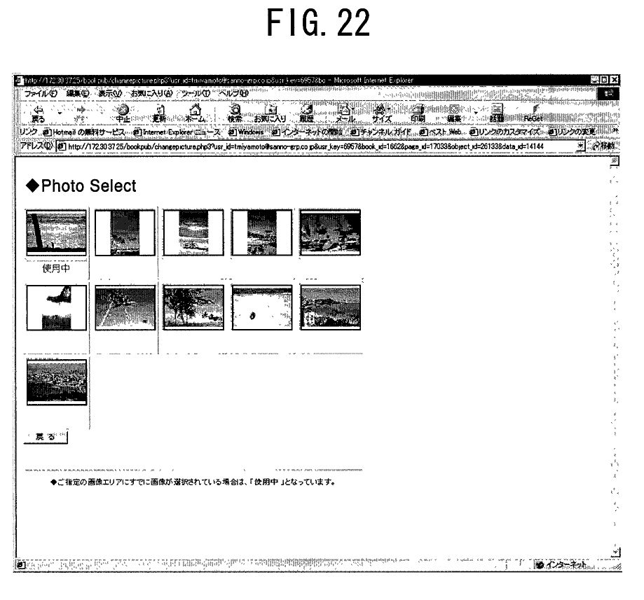

In the screen of FIG. 20, when the user clicks a certain areas for modifying images, for example, an image area 2005 (Step S261), the user terminal 5 and the editing system 1 mutually communicate about related information between (Steps S262˜S265), and then a “Photo Select” screen as shown in FIG. 22 is displayed on the user terminal 5 (Step S266). This screen includes one or more of displayed images in the form of thumbnail image or the like, as selectable images. When the user clicks and selects one desired image to be displayed (Step S267). Upon selecting the desired image, the user terminal 5 transmits the selected image to the editing system 1 (Step S268). The editing system 1 receives the selected image, and updates the binding data file 3-3 managed by the DB server 3 (Step S269), based on the received image. The editing system 1 transmits the “Making Report/Album (9)—Page Edition” screen to the user terminal 5 (Step S270), and then the user terminal 5 receives it (Step S271) to display the “Making Report/Album (9)—Page Edition” screen as shown in FIG. 20 again (Step S272).

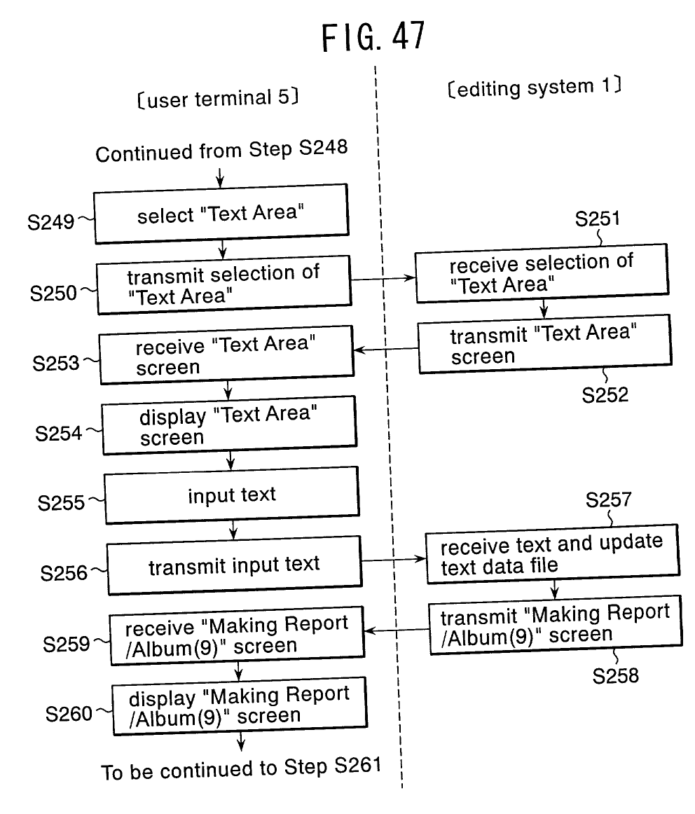

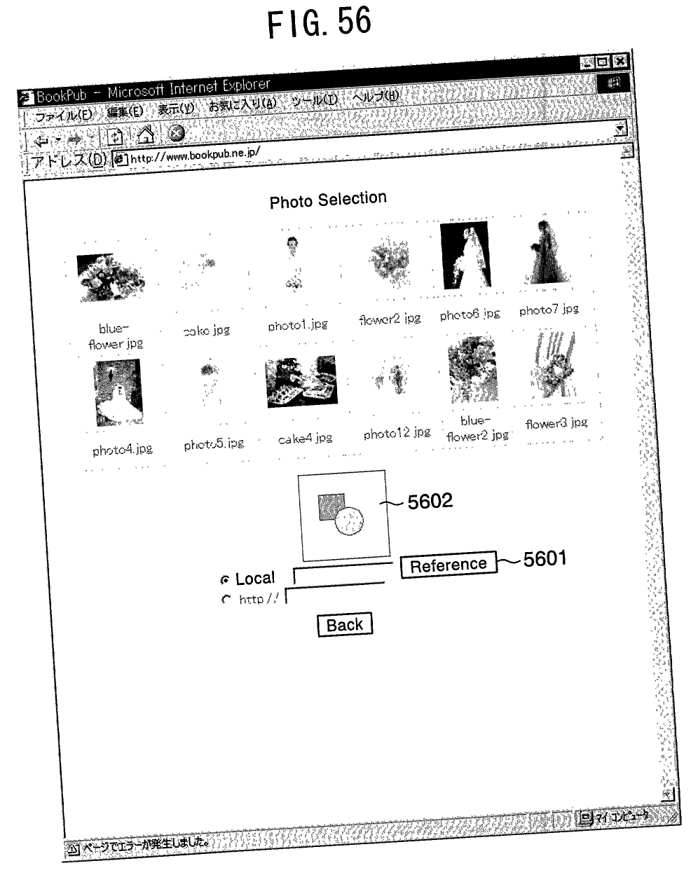

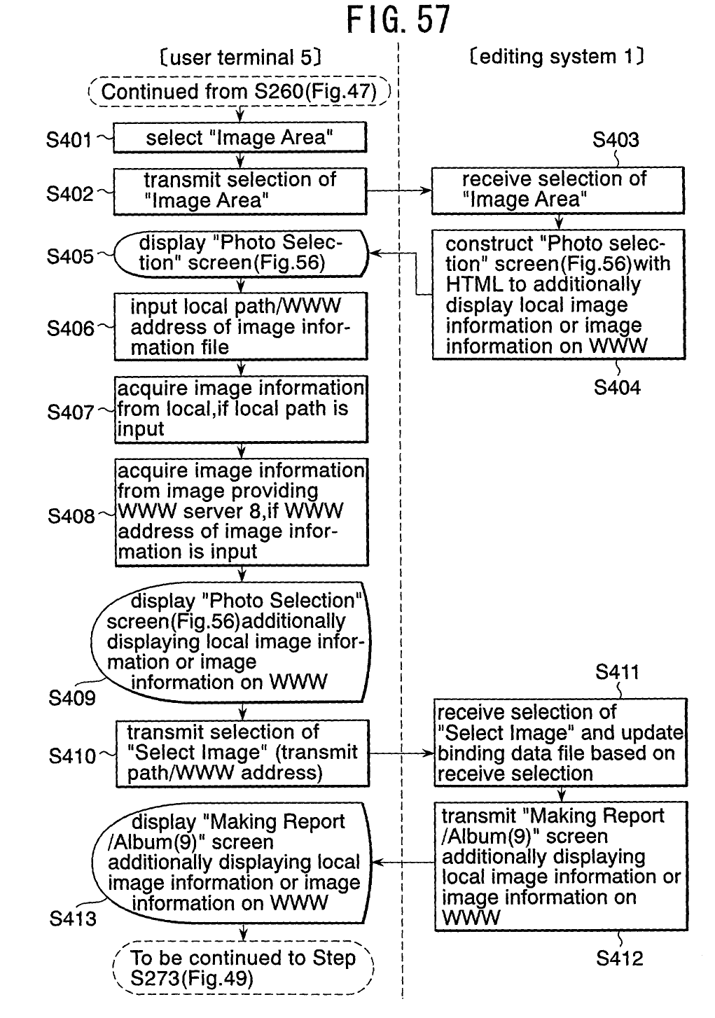

According to another aspect of the invention, in the aforementioned “Photo Selection” operation, as a substitution for the “Photo Selection” screen displaying only images registered in advance (FIG. 22), another “Photo Selection” screen (FIG. 56) is displayed which allows images to be added from the local image information in the user terminal 5 or the image information on the WWW. The operation will be now described with reference to FIG. 57. After the “Making Report/Album (9)” screen as shown in FIG. 20 has been displayed in aforementioned Step S260 (FIG. 47), when the user clicks a certain area for modifying images, for example, an image area 2005, the selected information is transmitted to the editing system 1 (Step S402). Upon receiving this information (Step S403), the editing system 1 constructs a “Photo Selection” screen (FIG. 56) and transmits it to the user terminal 5 (Step S404). Then, the user terminal 5 displays the “Photo Selection” screen (FIG. 56) (Step S405). In the upper column of this screen, images registered in the image data file 4-1 as the corresponding image information is displayed in the form of thumbnail image or the like. Each file name of the image information is indicated under each corresponding image. An input column is displayed in the lower section of the screen to additionally input images. The file path of the local image information stored in the user terminal 5 or the WWW address of the image information stored in the image providing WWW server 8 on the WWW may be input through the input column to acquire the image information file based on the input path or the WWW address and display the corresponding image on the user terminal 5.

In order to add the local image information into the selectable images, the “Local” radio button may be selected to input the file path through the input column. On the other hand, in order to add image information on the WWW into the selectable images, the “http://” radio button may be selected to input the WWW address (URL) of the image file stored in the image providing WWW server 8, through the input column. When a “Reference” button 5601 is selected, if the path has been input, the user terminal 5 accesses the image information file corresponding to the input file path (Step S407). If the WWW address has been input, the user terminal 5 requests and receives the image information file corresponding to the input WWW address to/from the image providing WWW server 8 (Step S408). The user terminal 5 displays an image presented by the input image information corresponding to the path or the WWW address, on the display area 5602 (Step S409). The user selects one or more of desired images from the thumbnail images in the upper column or the local images in the lower column or the images on the WWW to be added into the image area of the template. The user terminal 5 then transmits the selected image to the editing system 1 (Step S410). In this operation, if an image having the input path or the input WWW address is selected, the user terminal 5 transmits the path or WWW address to the editing system 1. Then, the editing system 1 receives the selected image to update the binding data file 3-3 for the subject publication managed by the DB server 3, based on the received path or WWW address (Step S411). The editing system 1 transmits a “Making Report/Album (9)—Page Edition” screen for displaying the input text and the selected image, to the user terminal 5 (Step S412), and the user terminal 5 receives it to display the “Making Report/Album (9) —Page Edition” screen as shown in FIG. 20 again (Step S413). In this case, the WWW server 2 may display an image presented by the image information which is not stored in the image data file 4-1, on the user terminal 5. When said screen is described with HTML, the above operation may be achieved by transmitting a screen described with the HTML from the WWW server 2 to the user terminal 5 so as to allow the user terminal 5 to access the file corresponding to the input path in the user terminal 5 and display the corresponding image or to acquire a desired file having the WWW address in the image providing WWW server 8 and display the corresponding image. In this case, since the image information having a large amount and file size is not transmitted from the WWW server 2 to the user terminal 5, the time required for the communication in transmitting the screen may be significantly shortened. This provides quick response and enhanced operational performance. The above is the description about the “Photo Selection” operation according to another aspect of the present invention. The operation will proceed to the subsequent step S273 as described later.

The user may process the aforementioned selectable images. This provides an opportunity that the user processes these images itself. For example, such image processing may, but not shown, be implemented as follows. Based on the image data managed by the file server 4, the user clicks and selects an image to be subjected to the image processing, from a registered image list displayed on the user terminal 5. Then, the image is selected as a subject to be processed, and an image processing window is displayed on the user terminal 5 to acquire the subject image from the image data file 4-1 and display on the user terminal. An “image Processing Menu” is displayed in the image-processing window to execute the image processing based on specified parameters. The “Image Processing Menu” displays parameters corresponding to functions, such as “Image Brightness Adjustment” for adjusting the underexposure or overexposure, “Image Resizing” for reducing large images or zooming small images, “Clipping” for clipping only a desired portion from a large image by use of a clipping template including circular, diamond, and other various shapes, “Frame” for drawing ornamental lines around the images, “Blurring” for blurring around the images, “Mosaic” for subjecting the images to a mosaic-processing, and others. The user selects a parameter to be modified from these parameters, and modifies the selected parameter by increasing or reducing the value of the selected parameter or otherwise modified the selected parameter with specifying a particular position by operating a mouse. After completing the image processing, by clicking a “Registration” button indicated in the image-processing window, the processed image may be registered in the image data file 4-1 managed by the file server 4. Furthermore, it is apparent that more microscopic processing, such as graphics processing, or processing in units of dot, may be applied instead of specifying parameters.

After completing the page edition, when an “End of Page Edition” button 2003 as shown in FIG. 20 (Step S273) is clicked, the user terminal 5 and the editing system 1 mutually communicate about related information (Steps S274 to S277), and then a “Making Report/Album (10)” screen is displayed on the user terminal 5 (Step S278). If the user wants to successively edit another page, the user may click the “Go” button for the “Edition” corresponding to the page and then continues the editing operation as described above. When the entire pages have been completely edited, the user clicks a “Completion of Editing Operation (Possible to Order)” button 2401. When the user wants to temporarily halt the editing operation with leaving some pages for the editing operation, the user may click a “Exit of Editing Operation (Under Edition)” button 2402. When either one of the buttons 2401 and 2402 is clicked (Step S279), the user terminal 5 and the editing system 1 mutually communicate about related information (Step S280 to S283) to display a “Making Report/Album (11)” screen on the user terminal 5 (Step 284).

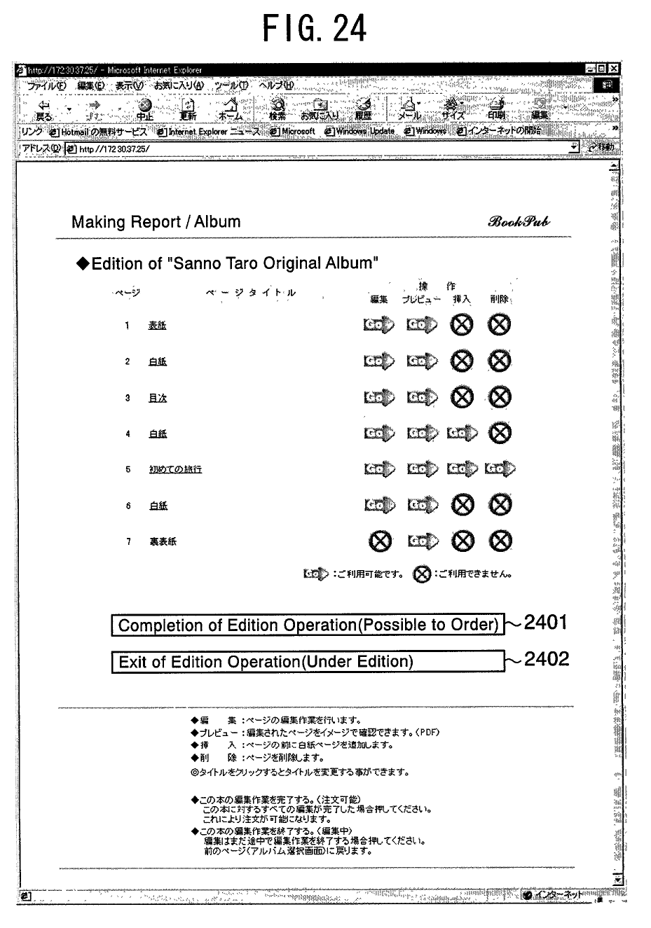

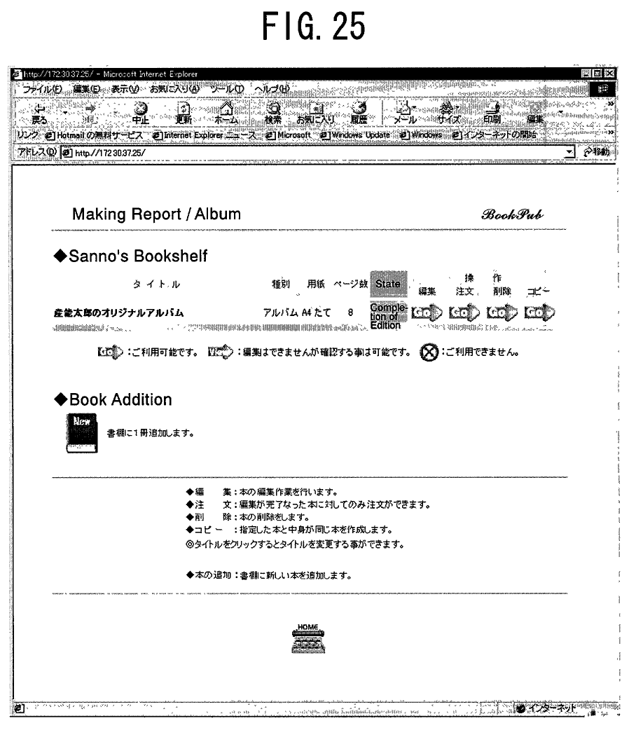

An example of a screen in FIG. 25 shows a list of publications of the“Sanno's Bookshelf” column in FIG. 24 in the state when the “Completion of Editing Operation (Possible to Order)” button 2401 is clicked 9. Thus, the “State” is indicated as “Completion of Edition”. If the “Exit of Editing Operation (Under Edition)” button 2402 in FIG. 24 is clicked, the “State” is indicated as “Under Edition” to indicate that the editing operation has not been completed yet. The above is all description about the editing operation of the binding data for the publication entitled as “Sanno Taro Original Album”.

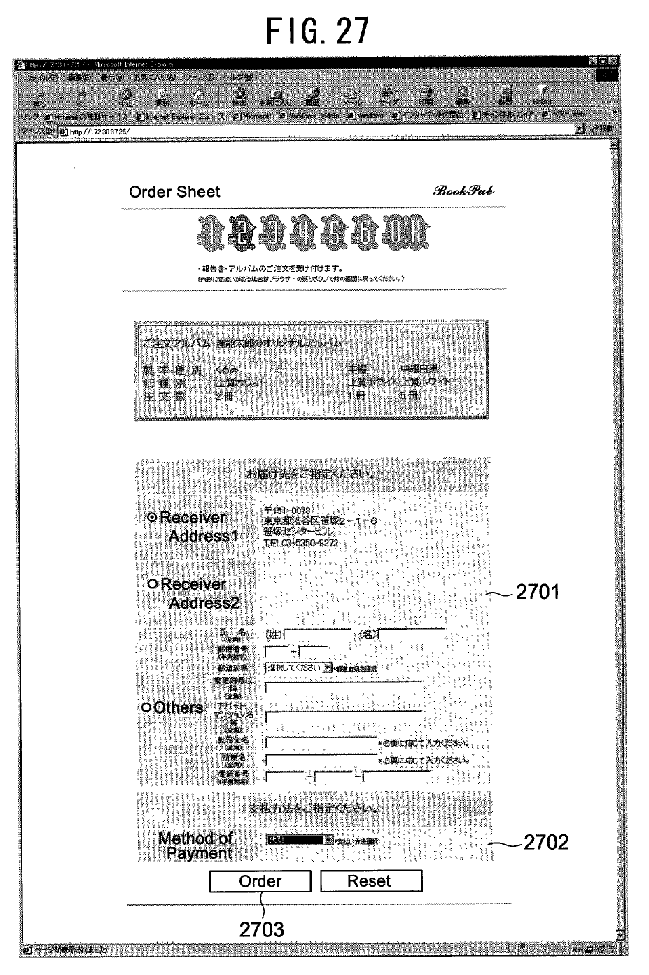

An operation for ordering books made through the printing/binding system 7 based on the above binding data will be now described. In a screen of FIG. 25, when the “Go” button for the “Order” is clicked (Step S285), the user terminal 5 and the editing system 1 mutually communicate about related information (Steps S286 to S289), and then an “Order Sheet (1)” screen as shown in FIG. 26 is displayed on the user terminal 5 (Step S290). The user may order desired books by inputting a binding process and the number of ordering books, through the screen. A “Type of Binding” input column 2601 for specifying the type of binding, such as casing, saddle stitching, saddle stitch B-W, a “Type of Paper” input column 2602 for specifying the type of paper, such as a woodfree W, and a “Quantity of Order” input column 2603 for inputting the number of ordering books are displayed on “Order Sheet (1)” screen, and a set of the above columns is displays for a first to third selected publications, respectively. When the user clicks a “▾” button for each input column, a pull-down menu with a selectable list is displayed, and thereby the user may select from the displayed list. After completing the input, when a “Registration” button 2604 is clicked (Step S291), the user terminal 5 and the editing system 1 mutually communicate about related information (Steps S292 to S295), and then an “Order Sheet (2)” screen as shown in FIG. 27 is displayed on the user terminal 5 (Step S296). The binding type, paper type and ordering book number, which have been input in FIG. 26, are displayed at the upper section of the screen to enable the used to user to check out them. A “Receiver Address” input column 2701 and a “Method of Payment” input column 2702 are displayed at the lower section of said screen. If the “Receiver Address” is equal to the registered address, the user inputs this message through the column 2701, while if the “Receiver Address” is different from the registered address, the user inputs this message and the receivers address. The user also inputs the method of payment through the “Method of Payment” input column 2702.

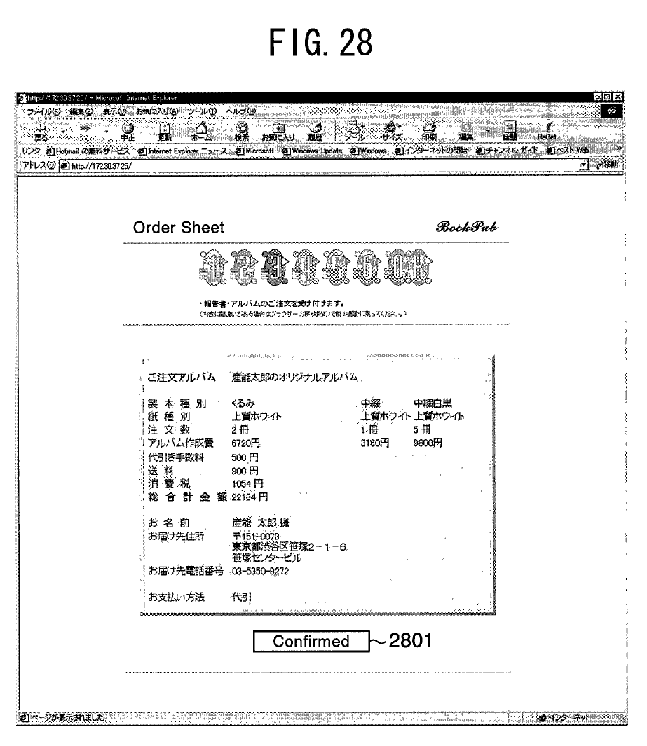

After completing each input for these columns, when an “Order” button 2703 is clicked (Step S297), the user terminal 5 and the editing system 1 mutually communicate about related information (Steps S298 to S301), and then an “Order Sheet (3)” screen as shown in FIG. 28 is displayed on the user terminal 5 (Step S302). The binding type, paper type and ordering book number, receiver address and payment method which have been input by now, are displayed on the screen to enable the used to user to check out them.

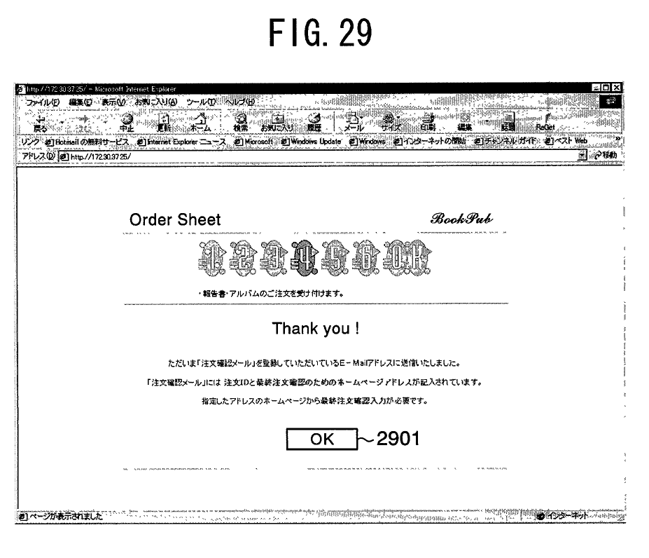

After checking out them, when a “Confirmed” button 2801 is clicked (Step S303), the user terminal 5 and the editing system 1 mutually communicate about related information (Steps S304˜S307), and then an “Order Sheet (4)” screen as shown in FIG. 29 is displayed on the user terminal 5 (Step S308). This screen displays each message indicating that the order is accepted, a “E-Mail for Confirmation of Order” describing an order ID and a homepage address for the final confirmation of the order been forwarded to the user, and a final confirmation of the order being required to be transmitted from the homepage having the address specified by the E-mail.

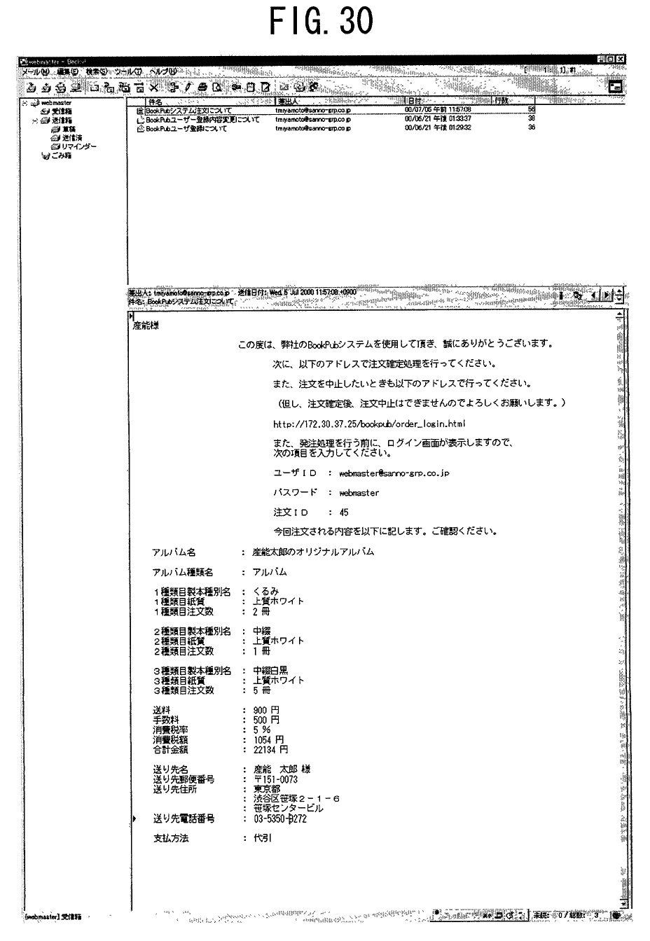

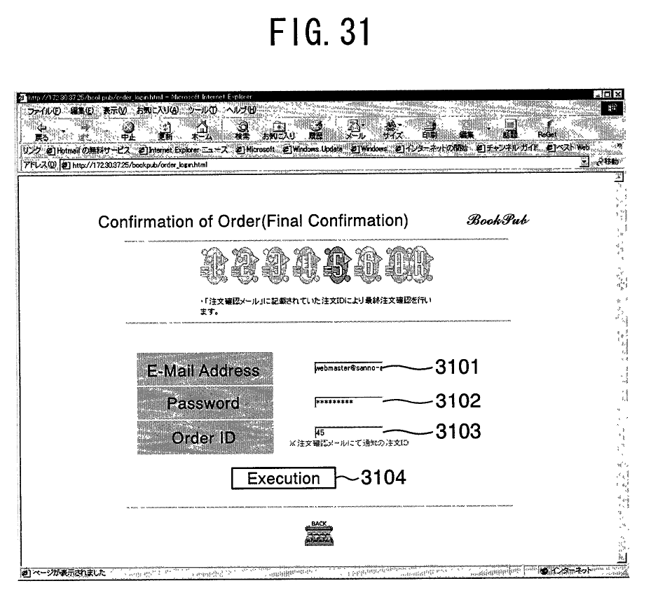

As shown in FIG. 30, by accessing the own E-mail address, the user may check out the “E-Mail for Confirmation of Order” sent through the above operation. When the user terminal 5 is connected with the homepage address for the final confirmation of the order (Step S309), the user terminal 5 and the editing system 1 mutually communicate about related information (Steps S310˜S311), and then an “Order Confirmation (Final Confirmation) (1)” screen as shown in FIG. 31 is displayed on the user terminal 5 (Step S312).

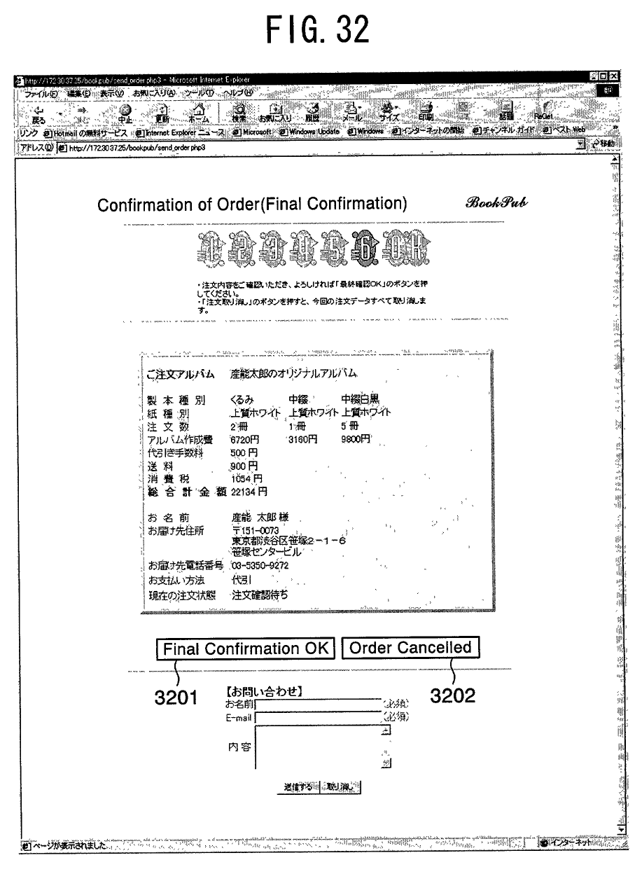

An “E-Mail Address” input column 3101, a “Password” input column 3102, and an “Order ID” input column 3103 and an “Order ID” input column for inputting “Order ID” informed by the “E-Mail for Confirmation of Order” are displayed on the screen of FIG. 31. After completing the input for these input columns, when the user clicks an “Execution” button 3104 (Step S313), the user terminal 5 and the editing system 1 mutually communicate about related information (Steps S314˜S317), and then an “Confirmation of Order (Final Confirmation) (2)” screen as shown in FIG. 32 is displayed on the user terminal 5 (Step S318).

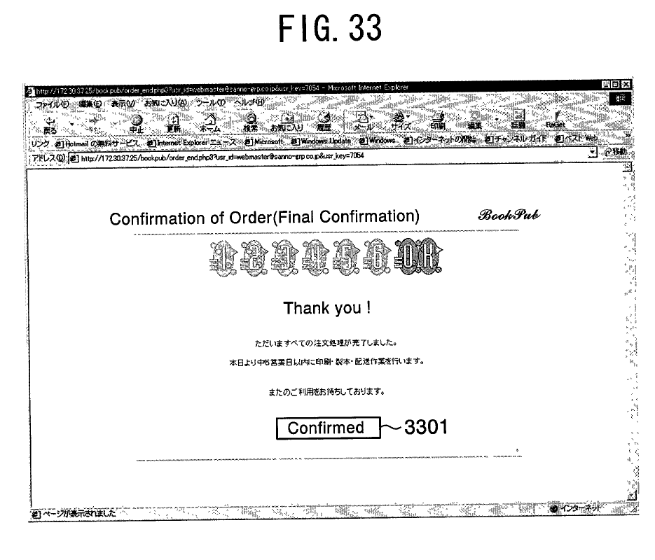

The state of order specified in the ordering operation by now is displayed on the screen as shown in FIG. 32. After checking out this display, if everything is correct, the user may click a “Final Confirmation OK” button 3201 (Step S319). As a result, the user terminal 5 and the editing system 1 mutually communicate about related information (Steps S320˜S323), and then an “Order Confirmed (Final Confirmation) (3)” screen as shown in FIG. 33 is displayed on the user terminal 5 (Step S324). On the other hand, if the display is not collect, the user may click an “Order Cancelled” button 3202. This allows the entire ordering operation by now to be canceled.

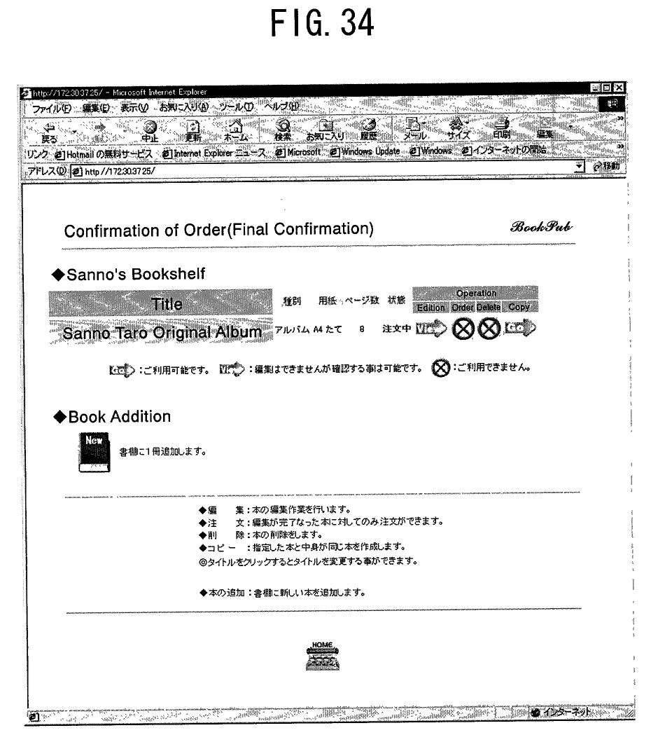

The screen of FIG. 33 displays a message indicating that the entire ordering process has been completed and a deadline for printing, binding and dispatching. After checking the display, the user may click a “Confirmed” button 3301 (Step S325). As a result, the user terminal 5 and the editing system 1 mutually communicate about related information (Steps S326 to S329), and a “Making Report/Album (12)” screen as shown in FIG. 34 is displayed on the user terminal 5 (Step S330). This screen displays the publication entitled “Sanno Taro Original Album” in the column of the “Sanno's Bookshelf”, and, a “X” button is indicated at the position of the “Order” associated with the “Operation” because the entire ordering operation has been completed as described above. A “View” button is indicated at the position of “Edition” associated with the “Operation” to indicate that the user cannot edit but check out. As with the screen of FIG. 12, a new publication may be added and edited by clicking a display area indicated as “Book Addition” through this screen. The above is the description about the operations for ordering books.

The above embodiment has been described in the state when the user terminal 5 and the editing system 1 are connected with each other via the Internet 6, i.e. in the on-line operation. However, the on-line operation is not economical because the telephone charge, the Internet service provider connection charge and others generally having a rate schedule are continuously imposed upon the user as long as the user terminal 5 is linked to the Internet 6, independently of the presence of the actual data transmission between the user terminal 5 and the editing system 1. In contrast, a template holding means employed in the present invention allows the publication editing operation to be economically managed, or to be performed even in an off-line state and by linking to the Internet 6 only when required to communicate with the editing system 1. In addition, since the data of images or the like to be displayed on the user terminal 5 is acquired not via the Internet but from a hard disk incorporated in the user terminal 5, the enhanced response speed to each operation and excellent operational performance can be achieved.

Preferably, the template holding means is a kind of application software which is transmitted from the editing system 1 to the user terminal 5 via the Internet 6, and operates on the user terminal 5. When the user terminal 5 an accesses the Edit Web site, it is judged whether the template holding means is necessary to be installed. If necessary, the template holding means is transmitted from the editing system 1 to the user terminal 5 by means of downloading or the like. The template holding means can selectively acquire the binding data, the template data, the text data and the image data, which are generated just after starting the editing operation for all or selected one of the user registration publications, from the editing system 1 via the Internet 6, and then stores these data temporarily in the hard disk or the like incorporated in the user terminal 5. After acquiring all of necessary date, the template holding means disconnects the link to the Internet 6. By the operation of the template holding means, the WWW browser reads out the template and/or other data, which are temporarily stored in the hard disk drive, and makes the user terminal 5 display these data as if the user terminal 5 operates on-line. As the user selects or modifies the selected image in the image area, or inputs texts into the text area through the template displayed on the WWW browser, various data stored in the hard disk, such as the binding data and text data, is updated by the function of the template data holding means. By virtue of the function of the template data holding means, the user may continuously perform the editing operation even in the off-line state of the user terminal by reflecting the result of the editing operation to a temporally file stored and expanded on the hard disk. After completing the editing operation, the template holding means makes the user terminal 5 link to the Internet 6, and transmits only the data updated through the edition operation among these data stored in the hard desk, to the editing system 1 via Internet 6 so as to reflect the entire editing operation implemented in the off-line state to the subject publication managed by the editing system 1.

The process for printing and binding the ordered book will now be described. When the editing system 1 receives an order from a user, the WWW server 2 acquires the layout sample file 3-2, the binding data file 3-3, and the text data file 3-4 relating to the ordered publication, from the DB server 3, and acquires the data of the image data file 4-1 from the file server 4. As to the image information having no information owned by the editing system 1 except for a file path thereof, the editing system 1 makes the user terminal 5 display a prompt screen for requesting to retransmit such image information file to the editing system 1 so as to acquire such image information. Further, as to the image information having no information owned by the editing system 1 except for a WWW address thereof, the editing system 1 requests the image providing WWW server 8 to retransmit the file corresponding to the WWW address so as to acquire image information. The WWW server 2 generates a publication electronic data file having a suitable format for printing, such as PDF, based on the acquired data. The WWW server 2 also generates an order data file composed of a binding type, paper type and the ordering book number, which are specified by the user. Further, the WWW server 2 transmits such publication electronic data and order data to the printing/binding system 7 via the network, such as the Internet 6. When said printing/binding system 7 is not liked to the network, such publication electronic data and order data may be stored in a recording medium, such as a MO disk, and be then transferred to the printing/binding system 7. The printing/binding system 7 puts the image data into prints according to the print-on-demand system and then binds the prints with attaching a cover specified by the user on the Edit Web site, based on said publication electronic data and said order data. The finished books are then delivered to the address specified by the user on the Edit Web site.

As long as the finished book is subject to be delivered to the address specified by the user, the printing/binding system 7 may be placed at any suitable location. However, placing the printing/binding system 7 in the vicinity of a shop including a bookshop provides an advantage in convenience superior to any prior arts. Specifically, just like purchasing a book at a bookshop, the user may collect the finished books made by use of the Edit Web site. For users who feel some uncertainty in the commercial delivery, this provides a significant reliable method for collecting the finished books.

As described above, the system of the present invention provides the following advantages.

By virtue of a publication editing system comprising: a user terminal used by a user who provides information on a publication; an editing computer connected with the user terminal and for editing the publication based on the information and instructions from the user; an image information storage means for allowing the editing computer to store image information provided from the user; a template data storage means for allowing the editing computer to store a data of a template to be displayed on a screen of the user terminal in combination with the image information; a template display means for displaying the image and template specified by the instructions from the user on the user terminal in combination with the image and template; a text input means for inputting a text through the template selectively combined with the image according to the instructions from the user terminal by the user; and a printing information forming means for forming printing information to allow the associated information with the input text and the combination of the image and the template to be output as the publication, a user may edit a publication by means of a simplified operation in which the text input and image selection are performed through the template which is displayed on the user terminal and composed of the combination of the text area for displaying texts and the image area for displaying images, without incorporating the DTP application in the user terminal.

The a template display means is adapted to transmit the image information, which includes a less amount of information than that of the corresponding image information stored in the image information storage means, to the user terminal. This provides a reduced file size of the image information to be transmitted to the user terminal, enhanced responsibility in display, and excellent operational performance.

The template display means may be adapted to allow a WWW browser operable on the user terminal to display the template. This advantageously provides a simplified and convenient publication editing operation through the WWW browser.

The template data holding means may hold the template data provided for the WWW browser by the template display means to allow the WWW browser to be applied in an editing operation through the template even in an off-line state of the user terminal. This enables the user to cut the telephone charge and the Internet service provider connection charge. Further, since the data of images or the like to be displayed on the user terminal 5 is acquired not via the Internet 6 but from the hard disk corporate in the user terminal 5, the response speed to operation is enhanced, and an excellent operational performance may be achieved.

The image information editing means may edit the image information stored in the image information storage means, according to a parameter specified from the user terminal by the user. This allows an easy processing of said image data.

The printing/binding means for printing and binding a required number of publications based on the printing information. This allows the user to edit and bind the edited publication only by necessary number specified on the Internet to provide finished books.

The printing/binding means may be placed in the vicinity of a shop including a bookshop. This allows the publication printed and bound by the printing/binding means to be appropriately collected at the shop. Further, the user may collect books in a reliable manner, just like the user purchases books at a bookshop.

By virtue of a publication editing system comprising: an image information path input means incorporated in the editing computer and for inputting a file path of image information in the user terminal, through the user terminal; an image position input means incorporated in the editing computer and for inputting positional information, which represents a position on the template of the image presented by the image information having the input path, through the user terminal in association with the image information; and a constructed screen display means incorporated in the editing computer and for constructing a display data, which allows the image presented by the image information having the input path and the text presented by the input text information to be displayed on the user terminal with arranging them at each corresponding position on the template presented by the positional information associated with each of the image information and the text information, and for transmitting the display data to the user terminal, the image information having a large amount and file size is not transmitted from the editing computer to the user terminal 5. Thus, the time required for the communication in transmitting the screen may be significantly shortened.

By virtue of a publication editing system comprising: an image information address input means incorporated in the editing computer and for inputting a file address of the image information in the image providing WWW server, through the user terminal; a provided image receiving means incorporated in the user terminal and for receiving the image information having the input address from the image providing WWW server by requesting the image information to the image providing WWW server; a provided image position input means incorporated in the editing computer and for inputting positional information, which represents a position on the template of the image presented by the image information having the input address, through the user terminal in association with the image information; and a constructed screen display means incorporated in the editing computer and for constructing a display data, which allows the image presented by the image information having the input path and the text presented by the input text information to be displayed on the user terminal with arranging them at each corresponding position on the template presented by the positional information associated with each of the image information and the text information, and for transmitting the display data to the user terminal, the publication editing operation may be effectively performed by using a wide range of image information existing on the WWW.

What is claimed is:

1. A publication editing system comprising:
a user terminal used by a user who provides information on a publication;
an editing computer connected with said user terminal and for editing the publication based on the information and instructions from said user;
an image information storage means for allowing said editing computer to store image information provided from said user;
a template data storage means for allowing said editing computer to store a data of a template to be displayed on a screen of said user terminal in combination with said image information;
a template display means for displaying the image and template in combination thereof on said screen of said user terminal, which are specified by the instructions from said user;
a text input means for inputting a text through said template combined with said image according to the instructions from said user terminal by said user; and
a printing information forming means for forming printing information to allow the associated information with said input text and the combination of said image and said template to be output as the publication.

2. A publication editing system as defined in claim 1, wherein said template display means is adapted to transmit the image information, which includes a less amount of information than that of the corresponding image information stored in said image information storage means, to said user terminal.

3. A publication editing system as defined in claim 1, wherein said template display means is adapted to allow a WWW browser operable on said user terminal to display said template.

4. A publication editing system as defined in claim 1, which further includes a template data holding means for holding the template data provided for said WWW browser by said template display means to allow said WWW browser to be applied in an editing operation through said template even in an off-line state of said user terminal.

5. A publication editing system as defined in claim 1, which further includes an image information editing means for editing the image information stored in said image information storage means, according to a parameter specified from said user terminal by said user.

6. A publication editing system as defined in claim 1 , which further includes a printing/binding means for printing and binding a required number of publications based on said printing information.

7. A publication editing system as defined in claim 6, wherein said printing/binding means is placed in the vicinity of a shop including a bookshop to allow said publication printed and bound by said printing/binding means to be appropriately collected at said shop.

8. A publication editing method of editing a publication based on information and instructions from a user who provides information on said publication, said publication editing method comprising the steps of:
storing image information provided from said user in an editing computer;
storing a data of a template to be displayed on a screen of a user terminal in combination with said image information, in said editing computer;
displaying the image and template in combination thereof on said screen of said user terminal, which are specified by instructions from said user;
inputting a text through said template combined with said image according to the instructions from said user terminal by said user; and
forming printing information to allow the associated information with said input text and the combination of said image and said template to be output as the publication.

9. A server for implementing a publication editing method of editing a publication based on information and instructions from a user who provides information on said publication, said publication editing method comprising the steps of:
storing image information provided from said user in an editing computer;
storing a data of a template to be displayed on a screen of a user terminal in combination with said image information, in said editing computer;
displaying the image and template in combination thereof on said screen of said user terminal, which are specified by instructions from said user;
inputting a text through said template combined with said image according to the instructions from said user terminal by said user; and
forming printing information to allow the associated information with said input text and the combination of said image and said template to be output as the publication.

10. A publication editing system comprising:
a user terminal used by a user who provides information on a publication;
an editing computer connected with said user terminal and for editing said publication based on the information and instructions from said user;
a template data storage means incorporated in said editing computer and for storing a template data representing a template to be displayed on a screen of said user terminal with an image and text arranged at a given position of said template;
a template display means incorporated in said editing computer and for transmitting said template data to said user terminal so as to display said template on said user terminal;
an image information path input means incorporated in said editing computer and for inputting a file path of image information in said user terminal, through said user terminal;
an image position input means incorporated in said editing computer and for inputting positional information in association with said image information through said user terminal, said positional information representing said position of the image on said template represented by said image information having said input path;
a text information input means incorporated in said editing computer and for inputting text information in association with said positional information representing said position on said template through said user terminal, said text information including a text to be displayed on said template;
a text information storage means incorporated in said editing computer and for storing said text information input by said text information input means, in association with said positional information of said input text information;
a constructed screen display means incorporated in said editing computer and for constructing a display data and transmitting said display data to said user terminal, said display data allowing the image represented by said image information having said input path and the text represented by said input text information to be displayed on said screen of said user terminal with them arranged at each corresponding position on said template represented by said positional information associated with each of said image information and said text information;
an image information input means incorporated in said editing computer and for inputting said image information having said input path through said user terminal;
an image information storage means incorporated in said editing computer and for storing said image information input by said image information input means, in association with said positional information of said image information; and
a printing information forming means incorporated in said editing computer and for forming printing information used for outputting a specific image as a publication, said specific image including said image represented by said stored image information and said text represented by said stored text information, which are arranged at each corresponding position on said template represented by said positional information associated with each of said image information and said text information.

11. A publication editing system comprising:
a user terminal used by a user who provides information on a publication;
an image providing WWW server connected with said user terminal and for providing image information to the WWW;
an editing computer connected with said user terminal and said image providing WWW server so as to edit said publication based on the information and instructions from said user;
a template data storage means incorporated in said editing computer and for storing a template data representing a template to be displayed on a screen of said user terminal with an image and text arranged at a given position of said template;
a template display means incorporated in said editing computer and for transmitting said template data to said user terminal so as to display said template on said user terminal;
an image information address input means incorporated in said editing computer and for inputting a file address of said image information in said image providing WWW server, through said user terminal;
a provided image receiving means incorporated in said user terminal and for receiving said image information having said input address from said image providing WWW server by requesting said image information to said image providing WWW server;
a provided image position input means incorporated in said editing computer and for inputting positional information in association with said image information through said user terminal, said positional information representing said position of the image on said template represented by said image information having said input address;
a text information input means incorporated in said editing computer and for inputting text information in association with said positional information representing said position on said template through said user terminal, said text information including a text to be displayed on said template;
a text information storage means incorporated in said editing computer and for storing said text information input by said text information input means, in association with said positional information of said input text information;
a constructed screen display means incorporated in said editing computer and for constructing a display data and transmitting said display data to said user terminal, said display data allowing the image represented by said image information having said input path and the text represented by said input text information to be displayed on said screen of said user terminal with them arranged at each corresponding position on said template represented by said positional information associated with each of said image information and said text information
an image information receive means incorporated in said editing computer and for receiving said image information having said input address from said image providing WWW server by requesting said image information to said image providing WWW server;
an image information storage means incorporated in said editing computer and for storing said image information received by said image information receive means, in association with said positional information of said image information; and
a printing information forming means incorporated in said editing computer and for forming printing information used for outputting a specific image as a publication, said specific image including said image represented by said stored image information and said text represented by said stored text information, which are arranged at each corresponding position on said template represented by said positional information associated with each of said image information and said text information.

12. A publication editing system as defined in claim 10 or 11, wherein said template display means is adapted to allow a WWW browser operable on said user terminal to display said template.

13. A publication editing system as defined in claim 10 or 11, which further includes a template data holding means for holding the template data provided for said WWW browser by said template display means to allow said WWW browser to be applied in an editing operation through said template even in an off-line state of said user terminal.

14. A publication editing system as defined in claim 10 or 11, which further includes a printing/binding means for printing and binding a required number of publications based on said printing information.

15. A publication editing system as defined in claim 14, wherein said printing/binding means is placed in the vicinity of a shop including a bookshop to allow said publication printed and bound by said printing/binding means to be appropriately collected at said shop.

16. A publication editing method of editing a publication based on information and instructions from a user who provides information on said publication, said method comprising the steps of:
storing a template data representing a template to be displayed on a screen of a user terminal with an image and text arranged at a given position of said template;
transmitting said template data to said user terminal so as to display said template on said user terminal;
inputting a file path of the image information in said user terminal, through said user terminal;
inputting positional information in association with said image information through said user terminal, said positional information representing said position of the image on said template represented by said image information having said input path;
inputting text information in association with said positional information representing said position of the image on said template through said user terminal, said text information including a text to be displayed on said template;
storing said text information input in said step of inputting text information, in association with said positional information of said input text information;
constructing a display data, which allows the image represented by said image information having said input path and the text represented by said input text information to be displayed on said screen of said user terminal with them arranged at each corresponding position on said template represented by said positional information associated with each of said image information and said text information, and then transmitting said display data to said user terminal;
inputting said image information having said input path, through said user terminal;
storing said image information input in said step of inputting said image information, in association with said positional information of said image information; and
forming printing information for outputting a specific image as a publication, said specific image including said image represented by said stored image information and said text represented by said stored text information, which are arranged at each corresponding position on said template represented by said positional information associated with each of said image information and said text information.

17. A publication editing method of editing a publication by use of image information provided by an image providing WWW server, based on the information and instructions through a user terminal from a user who provides information on said publication, said publication editing method comprising the steps of:
storing a template data representing a template to be displayed on a screen of a user terminal with an image and text arranged at a given position of said template;
transmitting said template data to said user terminal so as to display said template on said user terminal;
inputting a file address of said image information in said image providing WWW server, through said user terminal;
receiving said image information having said input address from said image providing WWW server by requesting said image information to said image providing WWW server;
inputting positional information in association with said image information through said user terminal, said positional information representing said position of the image on said template represented by said image information having said input address;
inputting text information in association with said positional information representing said position of the image on said template through said user terminal, said text information including a text to be displayed on said template;
storing said text information input in said step of inputting text information, in association with said positional information of said input text information;
constructing a display data and transmitting said display data to said user terminal, said display data allowing the image represented by said image information having said input path and the text represented by said input text information to be displayed on said screen of said user terminal with them arranged at each corresponding position on said template represented by said positional information associated with each of said image information and said text information;
receiving said image information having said input address from said image providing WWW server by requesting said image information to said image providing WWW server;
storing said image information received in said step of receiving said image information, in association with said positional information of said image information; and
forming printing information for outputting a specific image as a publication, said specific image including said image represented by said stored image information and said text represented by said stored text information, which are arranged each at corresponding position on said template represented by said positional information associated with each of said image information and said text information.
